(19) United States
(12) Patent Application Publication
(10) Pub. No.: US 2022/0232342 A1
(43) Pub. Date: Jul. 21, 2022

(54) AUDIO SYSTEM FOR ARTIFICIAL REALITY APPLICATIONS

(71) Applicant: Facebook Technologies, LLC, Menlo Park, CA (US)

(72) Inventors: Ashutosh Pandey, Columbus, OH (US); Buye Xu, Sammamish, WA (US); FNU Anurag Kumar, Bellevue, WA (US); Jacob Ryan Donley, Seattle, WA (US); Paul Thomas Calamia, Redmond, WA (US); DeLiang Wang, Dublin, OH (US); Chuming Zhao, Bellevue, WA (US); Nils Thomas Fritiof Lunner, Redmond, WA (US); Antonio John Miller, Woodinville, WA (US); Manoel Francisco Soares Neto, Kirkland, WA (US)

(21) Appl. No.: 17/714,638

(22) Filed: Apr. 6, 2022

Related U.S. Application Data
(60) Provisional application No. 63/191,865, filed on May 21, 2021.
(60) Provisional application No. 63/209,315, filed on Jun. 10, 2021.
(60) Provisional application No. 63/248,924, filed on Sep. 27, 2021.
(60) Provisional application No. 63/252,014, filed on Oct. 4, 2021.

(51) Int. Cl. H04S 7/00; H04S 3/00; H04R 1/40; G06N 3/04; G06N 3/08; G10L 21/0216

(52) U.S. Cl. CPC H04S 7/304; H04S 7/306; H04S 3/008; G10L 2021/02166; G06N 3/04; G06N 3/08; G10L 21/0216; H04R 1/406

(57) ABSTRACT

Embodiments of the present disclosure relate to an audio system for artificial reality applications. One or more transducers of the audio system output, in accordance with audio instructions, one or more ultrasonic pressure waves simulating a virtual audio source near an ear of a user of the headset. A controller of the audio system generates the audio instructions such that the one or more ultrasonic pressure waves form at least a portion of audio content for presentation to the user. An array of microphones of the audio system detects audio signals in a local area. A deep neural network of the audio system processes the detected audio signals to generate enhanced audio content, and the one or more transducers present the enhanced audio content to a user.

### CROSS REFERENCE TO RELATED APPLICATIONS

This application claims a priority and benefit to U.S. Provisional Patent Application Ser. No. 63/191,865, filed May 21, 2021, U.S. Provisional Patent Application Ser. No. 63/209,315, filed Jun. 10, 2021, U.S. Provisional Patent Application Ser. No. 63/248,924, filed Sep. 27, 2021, and U.S. Provisional Patent Application Ser. No. 63/252,014, filed Oct. 4, 2021, each of which is hereby incorporated by reference in its entirety.

### FIELD OF THE INVENTION

The present disclosure relates generally to artificial reality systems, and specifically relates to an audio system for artificial reality applications.

### BACKGROUND

In artificial reality applications, it is commonly desired to create a virtual sound to convince a user of an eyewear device (e.g., smart glasses) that a sound source is near a user's ear. This is typically hard to achieve for an eyewear device with open ear fitting, as the sound source is usually located in a temple arm of the eyewear device. Additionally, an audio output in a form factor of an eyewear device (e.g., audio glasses) has very tight constraints in relation to a size, power and weight. For the audio glasses design, there is a huge push towards trimming a size of the temple arm to make it more stylish (socially acceptable) and light weight.

In many digital signal processing and control applications, an amount of time TDSP used by a processor to produce an output sample y[k] from an input sample x[k] can degrade performance characteristics of a system being controlled by the processor. Therefore, keeping the amount of time TDSP below design limits is desirable. In addition, a frequency at which the input sample x[k] is processed—for producing an associated output sample y[k]—also contributes to the degradation of performance characteristics. Such a frequency is commonly referred to as a sampling frequency Fs with corresponding sampling period Ts=1/Fs, and thus keeping Ts below design limits is also desirable. Consequently, TDSP becomes constrained to an upper limit value not to exceed Ts, often requiring the processor to operate at extremely high clock rates and/or to execute multiple instructions in parallel, which could result in elevated power consumption dissipated as heat.

A task of multichannel speech enhancement is to improve the intelligibility and quality of a noisy speech by utilizing recording from multiple microphones. Traditional approaches use linear spatial filters, such as a minimum variance distortionless response (MVDR) beamformer, designed to preserve signals coming from a target source direction and attenuate signals from other directions. The approaches based on MVDR beamformer utilize spatial correlations of speech and noise to determine filter coefficients, which is convenient to use with unknown array geometries.

Another approach for multichannel speech enhancement is a supervised speech enhancement that utilizes deep neural networks (DNNs). For multichannel processing, DNNs are well suited for fixed array geometries. However, DNNs are not well suited for ad-hoc array processing as the DNNs require the input and the output size to be fixed. Ad-hoc array processing requires a network to be able to process a multichannel signal with unknown number of microphones and in any order. In other words, the network should be invariant to the number and the order of microphones. One approach to design such networks is to use processing blocks that are number and permutation invariant, such as global pooling and self-attention. Another approach is to use a novel transform average and concatenate module to handle unknown number and order of microphones. Yet another approach is to utilize a spatial-temporal network where a recurrent network is used for temporal processing and self-attention is used for spatial processing. An output corresponding to a target microphone is obtained by using a global pooling layer. Yet another approach is utilizing a two stage deep ad-hoc beamforming. In the first stage, top k microphones are selected. In the second stage, selected k signals are used for k-microphone speech enhancement.

For multichannel speech enhancement processing, DNNs are generally incorporated with traditional spatial filters. Another approach is to train a DNN with spatial features, such as inter-channel phase, time, and level difference. Yet another approach is based on end-to-end supervised training without any explicit spatial filtering. An end-to-end supervised model when combined with a traditional spatial filter (e.g., MVDR beamformer) and a DNN-based post filter can provide additional consistent and significant improvements when compared with a DNN-only one-stage or multistage scheme.

### SUMMARY

Embodiments of the present disclosure relate to an audio system for artificial reality applications. The audio system includes one or more transducers coupled to a headset and a controller coupled to the one or more transducers. The one or more transducers are configured to output, in accordance with audio instructions, one or more ultrasonic pressure waves simulating a virtual audio source near an ear of a user of the headset. The controller is configured to generate the audio instructions such that the one or more ultrasonic pressure waves form at least a portion of audio content for presentation to the user.

Embodiments of the present disclosure further relate to a method for digital signal processing. A set of signal samples is divided into a first set of samples and a second set of samples, wherein the first set of samples are associated with a more recent set of time values than the second set of samples. The first set of samples is processed using a first digital signal processor (DSP) of the headset. The second set of samples is processed using a second DSP of the headset, wherein the second DSP is slower than the first DSP. Outputs from the first DSP and the second DSP are combined to form a combined output for presentation to the user, the combined output representative of a filtering operation being applied to the set of signal samples.

Embodiments of the present disclosure further relate to an audio system of a headset for enhancing audio presented to a user of the headset. The audio system includes an array of microphones, a deep neural network (DNN) coupled to the array of microphones, and one or more transducers coupled to the DNN. The array of microphones are configured to detect audio signals in a local area of the headset. The DNN is configured to process the detected audio signals to generate enhanced audio content. The one or more transducers are configured to present the enhanced audio content to the user.

Embodiments of the present disclosure further relate to a method performed by an audio system of a headset for enhancing audio presented to a user of the headset. Audio signals are first detected via an array of microphones of the audio system. The detected audio signals are then processed using a DNN of the audio system to generate enhanced audio content. The enhanced audio content is presented to the user via one or more transducers of the audio system.

### BRIEF DESCRIPTION OF THE DRAWINGS

FIG. 1A is a perspective view of a headset implemented as an eyewear device, in accordance with one or more embodiments.

FIG. 1B is a perspective view of a headset implemented as a head-mounted display, in accordance with one or more embodiments.

FIG. 2 is a block diagram of an audio system, in accordance with one or more embodiments.

FIG. 3A illustrates an example presentation of near ear virtual sounds to a user of an audio system, in accordance with one or more embodiments.

FIG. 3B illustrates an example usage of phased array speakers for generating haptics and audio output, in accordance with one or more embodiments.

FIG. 4 is an example top view of a capacitive micromachined ultrasonic transducer, in accordance with one or more embodiments.

FIG. 5A illustrates an example topology of a piezoelectric micromachined ultrasonic transducer (PMUT), in accordance with one or more embodiments.

FIG. 5B illustrates an example array of PMUTs, in accordance with one or more embodiments.

FIG. 5C illustrates an example cross-section of a PMUT, in accordance with one or more embodiments.

FIG. 5D illustrates an example top view of a first PMUT array, in accordance with one or more embodiments.

FIG. 5E illustrates an example top view of a second PMUT array, in accordance with one or more embodiments.

FIG. 6 is a block diagram of a triple-path attentive recurrent network (TPARN) for an ad-hoc array multichannel speech enhancement, in accordance with one or more embodiments.

FIG. 7 is a block diagram of the TPARN architecture, in accordance with one or more embodiments.

FIG. 8A is a block diagram of a recurrent neural network in the TPARN architecture, in accordance with one or more embodiments.

FIG. 8B is a block diagram of an attention block in the TPARN architecture, in accordance with one or more embodiments.

FIG. 8C is a block diagram of a feedforward block in the TPARN architecture, in accordance with one or more embodiments.

FIG. 9 is a block diagram of an attentive dense convolutional network (ADCN) for multichannel speech enhancement, in accordance with one or more embodiments.

FIG. 10A is a block diagram of a dense block of the ADCN, in accordance with one or more embodiments.

FIG. 10B is a block diagram an attention block of the ADCN, in accordance with one or more embodiments.

FIG. 11A is a block diagram of a two-stage sound-enhancement architecture with a minimum variance distortionless response (MVDR) beamformer, in accordance with one or more embodiments.

FIG. 11B is a block diagram of a two-stage sound-enhancement architecture without a MVDR beamformer, in accordance with one or more embodiments.

FIG. 12A illustrates an example architecture for splitting a convolution calculation between two digital signal processing (DSP) paths, in accordance with one or more embodiments.

FIG. 12B illustrates an example timing diagram for the convolution split of FIG. 12A, in accordance with one or more embodiments.

FIG. 13 illustrates an example block diagram of a coefficient bank switching control, in accordance with one or more embodiments.

FIG. 14A illustrates an example signal processing architecture with a quantizer for splitting a convolution calculation between two DSP paths, in accordance with one or more embodiments.

FIG. 14B illustrates an example signal processing architecture with a nonlinear quantization for splitting a convolution calculation between two DSP paths, in accordance with one or more embodiments.

FIG. 15 is a flowchart illustrating a process for multi-channel speech enhancement at an audio system, in accordance with one or more embodiments, in accordance with one or more embodiments.

FIG. 16 depicts a block diagram of a system that includes a headset, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present disclosure are related to an audio system that uses a triple-path attentive recurrent network (TPARN) for ad-hoc multichannel speech enhancement in time-domain. The TPARN is designed by extending a single-channel dual-path model to a multichannel model by adding a third-path along a spatial dimension. A simple but effective attention along the channels is proposed to make TPARN suitable for ad-hoc array processing, i.e., the number of microphones and order invariant processing. The audio system may utilize a deep neural network (DNN) to directly (i.e., without a beamformer) enhance sound. In some embodiments, the DNN is a TPARN that has a multiple-input multiple-output (MIMO) architecture. The audio system receives signals from a microphone array, processes the received signals using the DNN to enhance one or more sounds (e.g., voice) in the local area. In some embodiments, the DNN may be trained using microphones in random locations and/or random numbers of microphones. In some embodiments, the DNN is part of a multi-stage system. For example, a first stage may be an attentive dense convolutional network (ADCN) model followed by the TPARN in the second stage.

In some embodiments, the audio system as part of a headset uses an array of micromachined ultrasound transducers (capacitive and/or piezoelectric) to provide content to a user in an audible range. The audio system uses ultrasound to generate a virtual sounds source that also provides haptic feedback to a user. The audio system includes a phased array of ultrasonic speakers that can output ultrasonic pressure waves that combine in a manner that simulates a virtual audio source near an ear of the user. This virtual audio source can be made to be quite close to the ear such that it appears that the user experiences haptics from the sound. In this manner, the presented audio may sound and feel like it is being whispered into an ear of the user.

In some embodiments, the audio system has an architecture that is based on distributing computation of an algorithm among slow and fast digital signal processing paths. A portion of the algorithm dependent on more recent information is executed on a fast processing path. A portion of the algorithm dependent on older information is executed on a slow processing path in such a way that outputs of each path become ready to be combined and generate the desired algorithm output in a timely manner.

Embodiments of the present disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

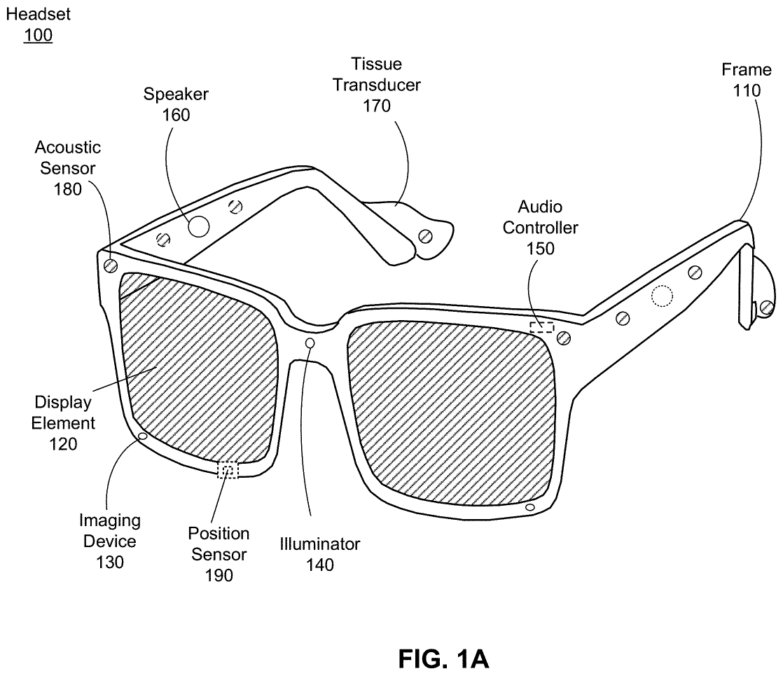

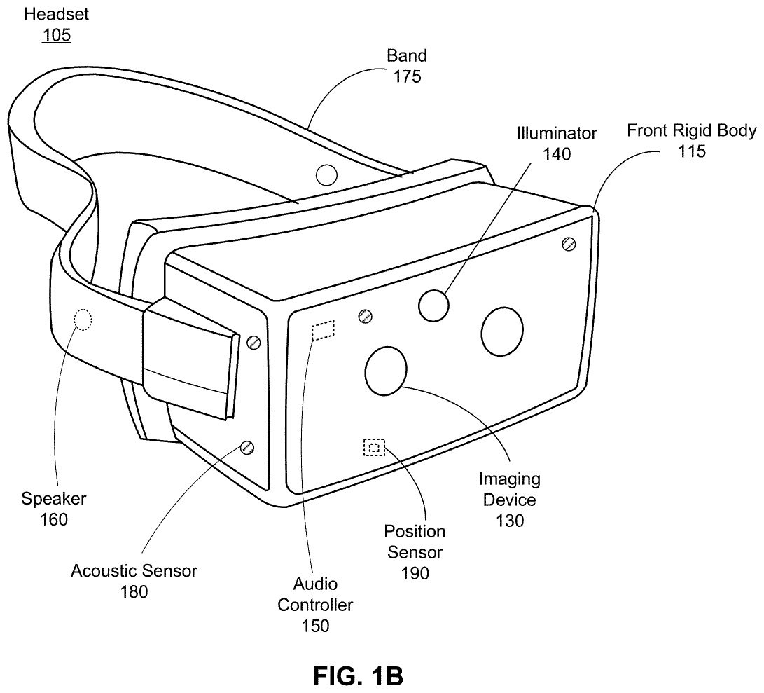

FIG. 1A is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame 110, and may include, among other components, a display assembly including one or more display elements 120, a depth camera assembly (DCA), an audio system, and a position sensor 190. While FIG. 1A illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1A.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, earpiece).

The one or more display elements 120 provide light to a user wearing the headset 100. As illustrated in FIG. 1A, the headset includes a display element 120 for each eye of a user. In some embodiments, a display element 120 generates image light that is provided to an eye box of the headset 100. The eye box is a location in space that an eye of the user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eye box of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eye box. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eye box. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1A), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1A shows a single illuminator 140 and two imaging devices 130. In alternate embodiments, there is no illuminator 140 and at least two imaging devices 130

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the audio controller 150 may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. The tissue transducer 170 couples to the head of the user and directly vibrates tissue (e.g., bone or cartilage) of the user to generate sound. In accordance with embodiments of the present disclosure, the transducer array comprises two transducers (e.g., two speakers 160, two tissue transducers 170, or one speaker 160 and one tissue transducer 170), i.e., one transducer for each ear. The locations of transducers may be different from what is shown in FIG. 1A.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1A. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a non-transitory computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

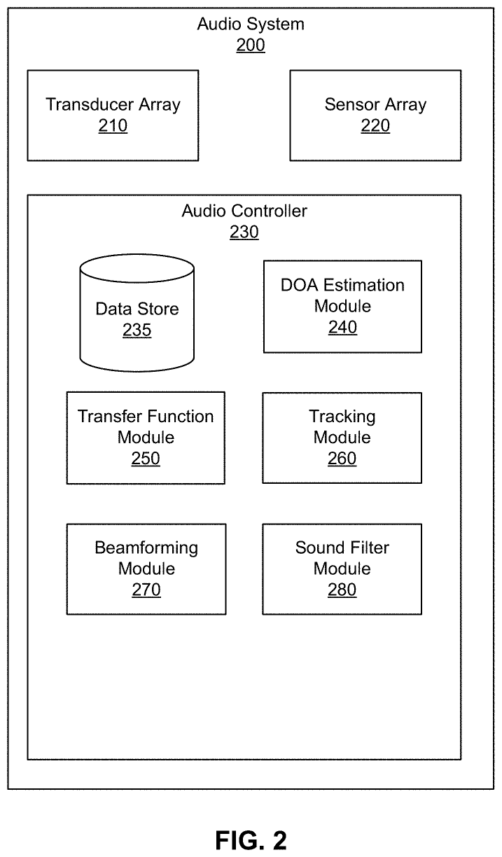

In some embodiments, the audio system is fully integrated into the headset 100. In some other embodiments, the audio system is distributed among multiple devices, such as between a computing device (e.g., smart phone or a console) and the headset 100. The computing device may be interfaced (e.g., via a wired or wireless connection) with the headset 100. In such cases, some of the processing steps presented herein may be performed at a portion of the audio system integrated into the computing device. For example, one or more functions of the audio controller 150 may be implemented at the computing device. More details about the structure and operations of the audio system are described in connection with FIG. 2.

The position sensor 190 generates one or more measurement signals in response to motion of the headset 100. The position sensor 190 may be located on a portion of the frame 110 of the headset 100. The position sensor 190 may include an IMU. Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

The audio system can use positional information describing the headset 100 (e.g., from the position sensor 190) to update virtual positions of sound sources so that the sound sources are positionally locked relative to the headset 100. In this case, when the user wearing the headset 100 turns their head, virtual positions of the virtual sources move with the head. Alternatively, virtual positions of the virtual sources are not locked relative to an orientation of the headset 100. In this case, when the user wearing the headset 100 turns their head, apparent virtual positions of the sound sources would not change.

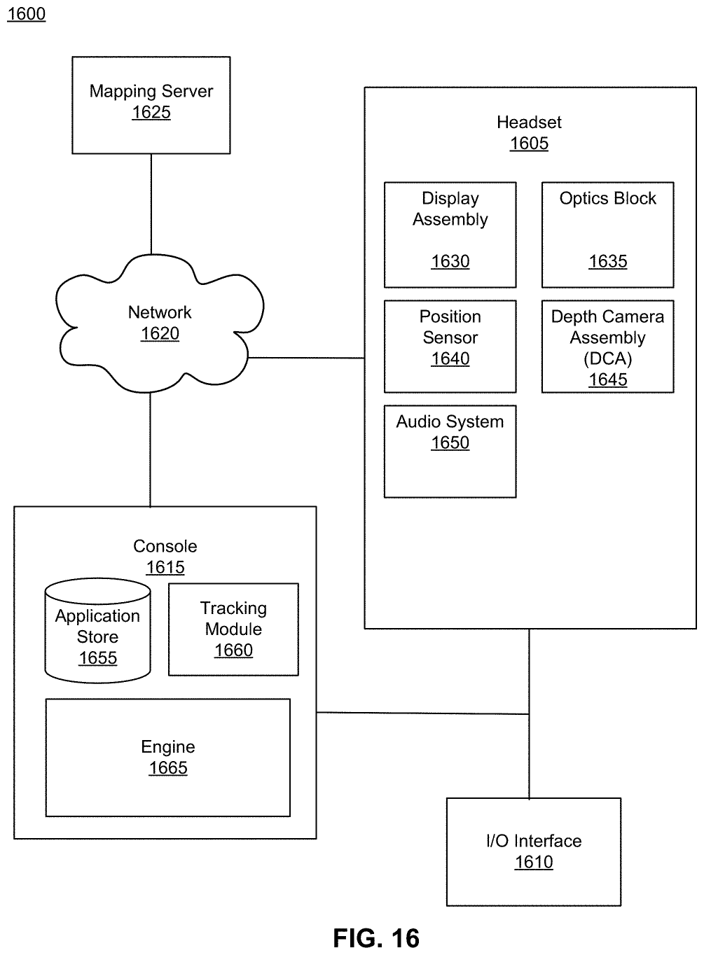

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 2 and FIG. 16.

FIG. 1B is a perspective view of a headset 105 implemented as a head-mounted display (HMD), in accordance with one or more embodiments. In embodiments that describe an AR system and/or a MR system, portions of a front side of the HMD are at least partially transparent in the visible band (˜380 nm to 750 nm), and portions of the HMD that are between the front side of the HMD and an eye of the user are at least partially transparent (e.g., a partially transparent electronic display). The HMD includes a front rigid body 115 and a band 175. The headset 105 includes many of the same components described above with reference to FIG. 1A but modified to integrate with the HMD form factor. For example, the HMD includes a display assembly, a DCA, an audio system, and a position sensor 190. FIG. 1B shows the illuminator 140, a plurality of the speakers 160, a plurality of the imaging devices 130, a plurality of acoustic sensors 180, and the position sensor 190. The speakers 160 may be located in various locations, such as coupled to the band 175 (as shown), coupled to the front rigid body 115, or may be configured to be inserted within the ear canal of a user.

FIG. 2 is a block diagram of an audio system 200, in accordance with one or more embodiments. The audio system in FIG. 1A or FIG. 1B may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a pair of transducers, i.e., one transducer for each ear. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or two speakers), via bone conduction (via one or two bone conduction transducer), via cartilage conduction audio system (via one or two cartilage conduction transducers), or some combination thereof.

The bone conduction transducers generate acoustic pressure waves by vibrating bone/tissue in the user's head. A bone conduction transducer may be coupled to a portion of a headset, and may be configured to be behind the auricle coupled to a portion of the user's skull. The bone conduction transducer receives vibration instructions from the audio controller 230, and vibrates a portion of the user's skull based on the received instructions. The vibrations from the bone conduction transducer generate a tissue-borne acoustic pressure wave that propagates toward the user's cochlea, bypassing the eardrum.

The cartilage conduction transducers generate acoustic pressure waves by vibrating one or more portions of the auricular cartilage of the ears of the user. A cartilage conduction transducer may be coupled to a portion of a headset, and may be configured to be coupled to one or more portions of the auricular cartilage of the ear. For example, the cartilage conduction transducer may couple to the back of an auricle of the ear of the user. The cartilage conduction transducer may be located anywhere along the auricular cartilage around the outer ear (e.g., the pinna, the tragus, some other portion of the auricular cartilage, or some combination thereof). Vibrating the one or more portions of auricular cartilage may generate: airborne acoustic pressure waves outside the ear canal; tissue born acoustic pressure waves that cause some portions of the ear canal to vibrate thereby generating an airborne acoustic pressure wave within the ear canal; or some combination thereof. The generated airborne acoustic pressure waves propagate down the ear canal toward the ear drum.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a pair of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, a beamforming module 270, and a sound filter module 280. The audio controller 230 may be located inside a headset, in some embodiments. Some embodiments of the audio controller 230 have different components than those described here. Similarly, functions can be distributed among the components in different manners than described here. For example, some functions of the audio controller 230 may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include sounds recorded in the local area of the audio system 200, audio content, HRTFs, transfer functions for one or more sensors, array transfer functions (ATFs) for one or more of the acoustic sensors, sound source locations, virtual model of local area, direction of arrival estimates, sound filters, virtual positions of sound sources, multi-source audio signals, signals for transducers (e.g., speakers) for each ear, and other data relevant for use by the audio system 200, or any combination thereof. The data store 235 may be implemented as a non-transitory computer-readable storage medium.

The user may opt-in to allow the data store 235 to record data captured by the audio system 200. In some embodiments, the audio system 200 may employ always on recording, in which the audio system 200 records all sounds captured by the audio system 200 in order to improve the experience for the user. The user may opt in or opt out to allow or prevent the audio system 200 from recording, storing, or transmitting the recorded data to other entities.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival. These algorithms may include, for example, delay and sum algorithms where the input signal is sampled, and the resulting weighted and delayed versions of the sampled signal are averaged together to determine a DOA. A least mean squared (LMS) algorithm may also be implemented to create an adaptive filter. This adaptive filter may then be used to identify differences in signal intensity, for example, or differences in time of arrival. These differences may then be used to estimate the DOA. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct path audio signal. Those bins having a portion of the direct-path signal may then be analyzed to identify the angle at which the sensor array 220 received the direct-path audio signal. The determined angle may then be used to identify the DOA for the received input signal. Other algorithms not listed above may also be used alone or in combination with the above algorithms to determine DOA.

In some embodiments, the DOA estimation module 240 may also determine the DOA with respect to an absolute position of the audio system 200 within the local area. The position of the sensor array 220 may be received from an external system (e.g., some other component of a headset, an artificial reality console, a mapping server, a position sensor (e.g., the position sensor 190, etc.). The external system may create a virtual model of the local area, in which the local area and the position of the audio system 200 are mapped. The received position information may include a location and/or an orientation of some or all of the audio system 200 (e.g., of the sensor array 220). The DOA estimation module 240 may update the estimated DOA based on the received position information.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be ATFs, HRTFs, other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

In some embodiments, the transfer function module 250 determines one or more HRTFs for a user of the audio system 200. The HRTF characterizes how an ear receives a sound from a point in space. The HRTF for a particular source location relative to a person is unique to each ear of the person (and is unique to the person) due to the person's anatomy (e.g., ear shape, shoulders, etc.) that affects the sound as it travels to the person's ears. In some embodiments, the transfer function module 250 may determine HRTFs for the user using a calibration process. In some embodiments, the transfer function module 250 may provide information about the user to a remote system. The user may adjust privacy settings to allow or prevent the transfer function module 250 from providing the information about the user to any remote systems. The remote system determines a set of HRTFs that are customized to the user using, e.g., machine learning, and provides the customized set of HRTFs to the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond. The tracking module may compare the current DOA estimates with previous DOA estimates, and in response to a change in a DOA estimate for a sound source, the tracking module 260 may determine that the sound source moved. In some embodiments, the tracking module 260 may detect a change in location based on visual information received from the headset or some other external source. The tracking module 260 may track the movement of one or more sound sources over time. The tracking module 260 may store values for a number of sound sources and a location of each sound source at each point in time. In response to a change in a value of the number or locations of the sound sources, the tracking module 260 may determine that a sound source moved. The tracking module 260 may calculate an estimate of the localization variance. The localization variance may be used as a confidence level for each determination of a change in movement.

The beamforming module 270 is configured to process one or more ATFs to selectively emphasize sounds from sound sources within a certain area while de-emphasizing sounds from other areas. In analyzing sounds detected by the sensor array 220, the beamforming module 270 may combine information from different acoustic sensors to emphasize sound associated from a particular region of the local area while deemphasizing sound that is from outside of the region. The beamforming module 270 may isolate an audio signal associated with sound from a particular sound source from other sound sources in the local area based on, e.g., different DOA estimates from the DOA estimation module 240 and the tracking module 260. The beamforming module 270 may thus selectively analyze discrete sound sources in the local area. In some embodiments, the beamforming module 270 may enhance a signal from a sound source. For example, the beamforming module 270 may apply sound filters which eliminate signals above, below, or between certain frequencies. Signal enhancement acts to enhance sounds associated with a given identified sound source relative to other sounds detected by the sensor array 220.

The sound filter module 280 determines sound filters for the transducer array 210. In some embodiments, the sound filters cause the audio content to be spatialized, such that the audio content appears to originate from a target region. The sound filter module 280 may use HRTFs and/or acoustic parameters to generate the sound filters. The acoustic parameters describe acoustic properties of the local area. The acoustic parameters may include, e.g., a reverberation time, a reverberation level, a room impulse response, etc. In some embodiments, the sound filter module 280 calculates one or more of the acoustic parameters. In some embodiments, the sound filter module 280 requests the acoustic parameters from a mapping server (e.g., as described below with regard to FIG. 16).

The sound filter module 280 provides the sound filters to the transducer array 210. In some embodiments, the sound filters may cause positive or negative amplification of sounds as a function of frequency. In some embodiments, audio content presented by the transducer array 210 is multi-channel spatialized audio. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200.

In some embodiments, the audio system 200 utilizes a TPARN for multichannel speech enhancement in time-domain. In some other embodiments, the audio system 200 performs digital signal processing by distributing computation of a digital signal processing algorithm among slow and fast digital signal processing paths. In yet some other embodiments, the transducer array 210 of the audio system 200 includes an array of ultrasound transducers for generating virtual sounds source(s) to emulate haptic feedback to a user of the audio system 200.

### Ultrasound Speakers in Artificial Reality Headsets

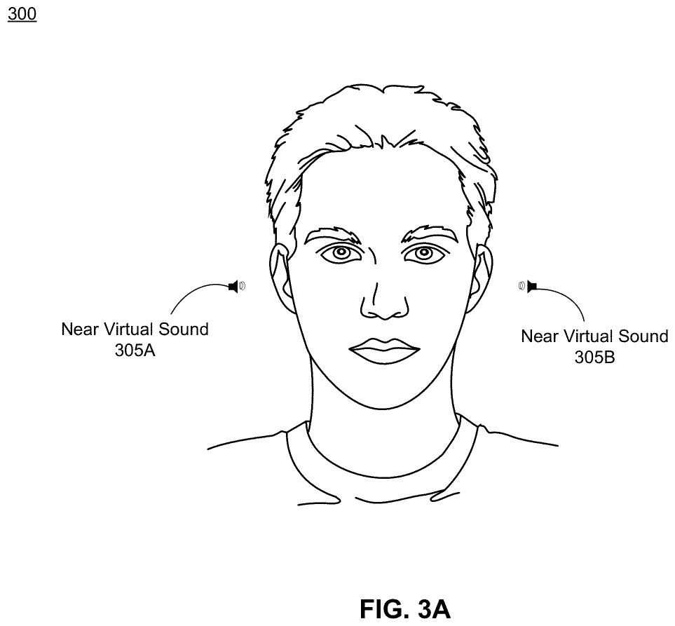

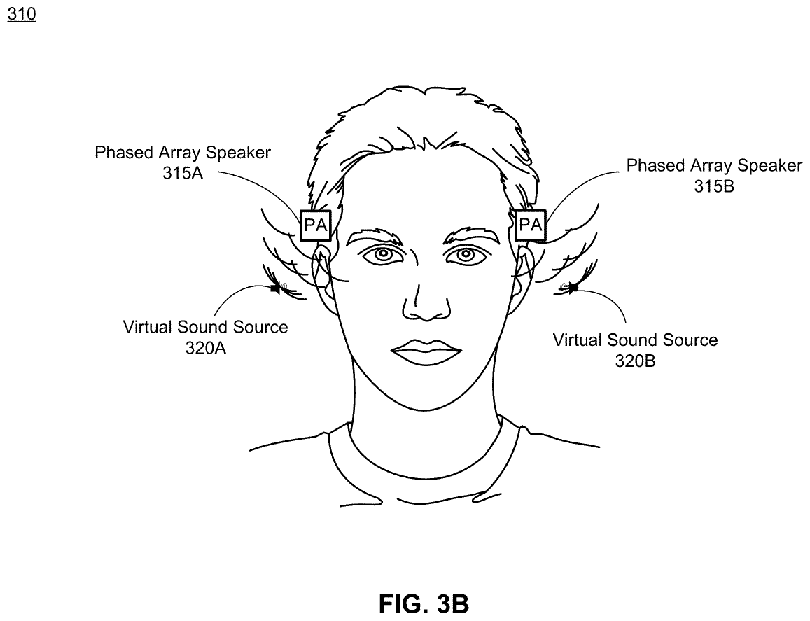

FIG. 3A illustrates an example presentation 300 of near ear virtual sounds to a user of an audio system, in accordance with one or more embodiments. In artificial reality applications, it is often desirable to create one or more virtual sounds to convince the user that the one or more sound sources are near a user's ear. As shown in FIG. 3A, a near virtual sound 305A can be presented to a right user's ear, and a near virtual sound 305B can be presented to a left user's ear. There are certain challenges for achieve desired near-sound effects, especially for an open ear fitting of an eyewear device (headset) worn by the user, as the sound source is typically located in a temple arm of the eyewear device.

FIG. 3B illustrates an example usage 310 of phased array (PA) speakers 315A, 315B for generating haptics and audio output, in accordance with one or more embodiments. Each PA speaker 315A, 315B may generate an ultrasound converging to a dedicated location to cause air to vibrate such that to create haptics sensation of a nearby virtual sound source. The PA speaker 315A may generate a first ultrasound that creates haptics sensation of a nearby virtual sound source 320A. Similarly, the PA speaker 315B may generate a second ultrasound that creates haptics sensation of a nearby virtual sound source 320B. The virtual sound sources 320A, 320B may be generated by the converging air molecule vibrations from the PA speakers 315A, 315B. For example, an audio output may focus on the broadband 20 Hz to 20 kHz in 40 dB-140 dB sound pressure level (SPL) output. Each PA speaker 315A, 315B may be implemented as an ultrasound PA of speakers. Furthermore, each PA speaker 315A, 315B may be mounted on a on a headset (not shown in FIG. 3B). The PA speakers 315A, 315B may be an embodiment of the transducer array 210.

Ultrasonic micromachined transducers, including a piezoelectric micromachined ultrasonic transducer (PMUT) and a capacitive micromachined ultrasonic transducer (CMUT), have been widely used for fingerprint sensing, gesture recognition, and portable medical ultrasound systems. PMUTs and CMUTs usually operate in the ultrasonic frequency range, e.g., in the frequency range greater than 20 kHz. Some embodiments of the present disclosure are directed to small sized PMUTs and CMUTs that operating towards the audio frequency output (e.g., 20 Hz to 20 kHz).

The CMUT and PMUT transducers presented herein are utilized to produce audio-band frequency output by modulating audio signals into ultrasonic carrier signals. Both CMUT and PMUT transducers have resonances in ultrasonic frequency ranges. Both CMUT and PMUT transducers have an array of small transducer diaphragms on the same chip. Through modulation, the ultrasound signals can be converted into the audio frequency output. By operating in the ultrasonic frequency range, substantial savings on the size and weight of the transducer can be achieved. Additionally, acoustic leakage/privacy issues can be efficiently mitigated by utilizing the CMUT and/or PMUT transducers operating in the ultrasonic frequency range. Also, vibrations that penetrate a headset and thus causing problems for accurate operations of IMU and other optic components may be also mitigated by utilizing the CMUT and/or PMUT transducers operating in the ultrasonic frequency range.

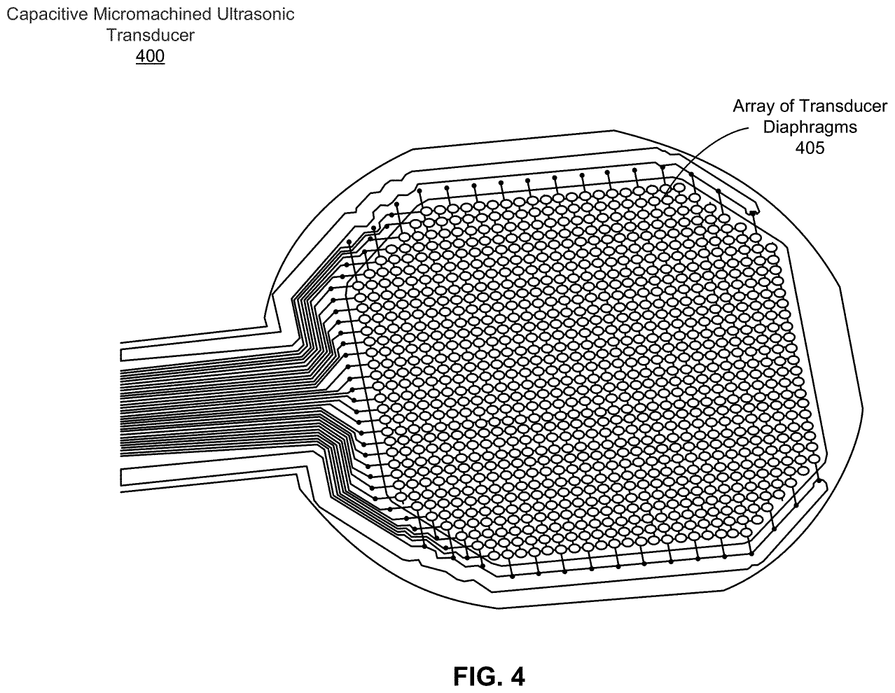

FIG. 4 illustrates an example top view of a CMUT 400, in accordance with one or more embodiments. As shown in FIG. 4, the CMUT 400 includes an array of transducer diaphragms 405 positioned on the same chip. The CMUT 400 may generate an audio-band output by modulating audio content into ultrasonic carrier signals. The CMUT 400 may be integrate and utilized within an audio system (e.g., the audio system 200) mounted on a headset (e.g., smart eyeglasses) with a smart form factor. The CMUT 400 may be an embodiment of a transducer in the transducer array 210.

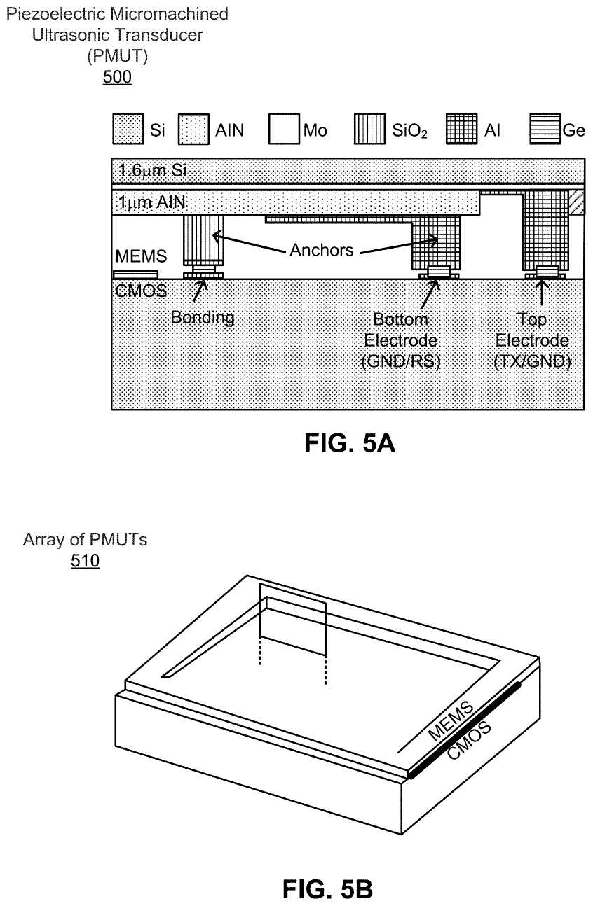

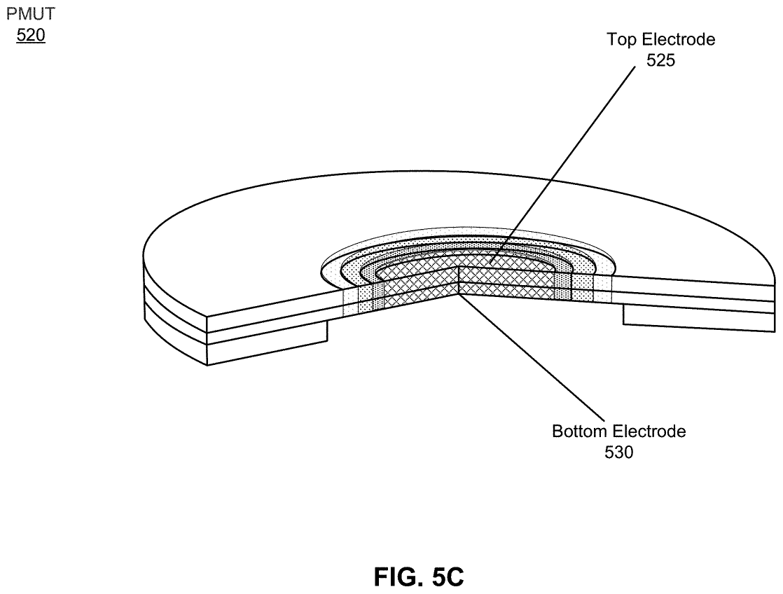

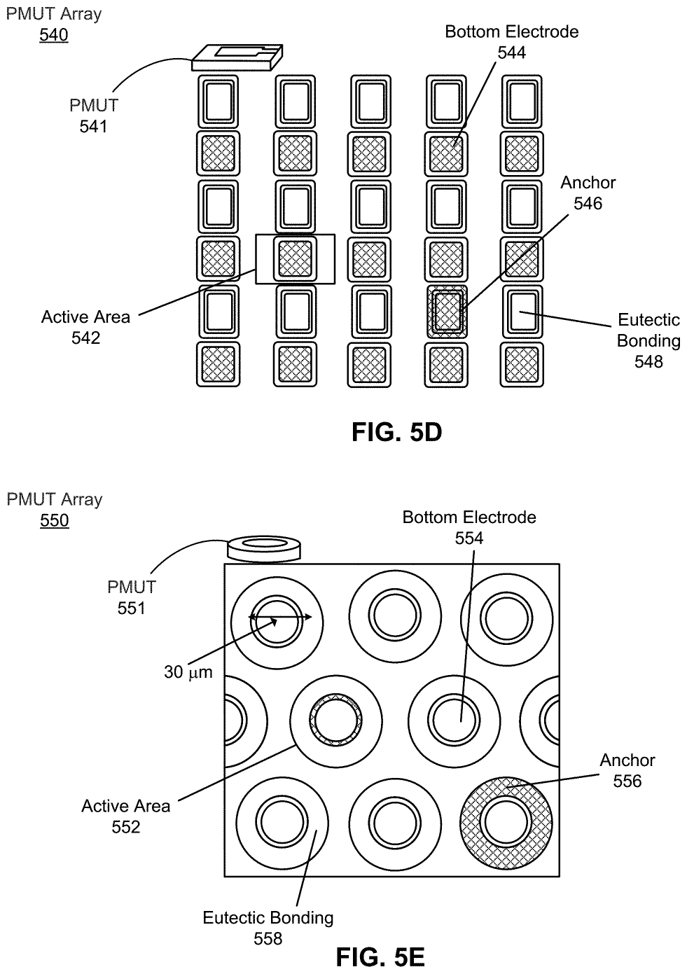

FIG. 5A illustrates an example topology of a PMUT 500, in accordance with one or more embodiments. FIG. 5B illustrates an example array of PMUTs 510, in accordance with one or more embodiments. For example, the array of PMUTs 510 may be an array of 110×56 PMUTs. The array of PMUTs 510 may be an embodiment of the transducer array 210.

FIG. 5C illustrates an example cross-section of a PMUT 520, in accordance with one or more embodiments. The PMUT 520 includes a top electrode 525 implemented as, e.g., a piezoelectric conductive sensing layer coupled to a first surface of the PMUT 520. The PMUT 520 further includes a bottom electrode 530 implemented as, e.g., a piezoelectric conductive sensing layer coupled to a second surface of the PMUT 520 opposite to the first surface. Outputs of the first and second conductive sensing layers (e.g., outputs of the top and bottom electrodes 525, 530) form output information (e.g., charge or voltage) responsive to a stress induced in the PMUT 520 by displacement of one or more moving components of the PMUT 520. The PMUT 520 may be an embodiment of a transducer in the transducer array 210.

FIG. 5D illustrates an example top view of a PMUT array 540, in accordance with one or more embodiments. The PMUT array 540 includes an array of PMUTs 541, and each PMUT 541 in the PMUT array 540 may be of, e.g., a square or rectangular shape. Each PMUT 541 in the PMUT array 540 includes an active area 542 surrounding an area of a bottom electrode 544. The PMUT array 540 further includes an anchor 546 and a eutectic bonding 548. Separation between two adjacent PMUTs 541 in the PMUT array 540 may be, e.g., less than 30 μm. The PMUT array 540 may be an embodiment of the transducer array 210.

FIG. 5E illustrates an example top view of a PMUT array 550, in accordance with one or more embodiments. The PMUT array 550 includes an array of PMUTs 551, and each PMUT 551 in the PMUT array 550 may be of an oval (e.g., circular) shape. Each PMUT 551 in the PMUT array 550 includes an active area 552 surrounding an area of a bottom electrode 554. A width of the bottom electrode 554 may be, e.g., less than 30 μm. The PMUT array 550 may further include an anchor 556. Each PMUT 551 in the PMUT array 550 may also include a eutectic bonding 558 implemented as a ring surrounding the bottom electrode 554. The PMUT array 550 may be an embodiment of the transducer array 210.

Some embodiments of the present disclosure relate to different methods of integrating and utilizing the presented CMUT and PMUT transducers for a smart eyeglasses with a small form factor. In some embodiments, the CMUT and/or PMUT transducers are utilized in conjunction with a waveguide for achieving flexibility of transducer placement. Given tight space budget on a smart eyeglasses, it is not always possible to place a CMUT and/or PMUT transducer at a most desired location for acoustic radiation efficiency. However, the CMUT and/or PMUT transducer(s) may be at any locations that are physically allowed on the smart eyeglasses and include one or more ultrasound waveguides (e.g., horn, duct, or metamaterial waveguide) guiding the sound to the ideal porting locations to increase the transduction efficiency. Additionally, impedance matching membranes or material may be used at the porting location for optimal acoustic radiation efficiency.

In some other embodiments, instead of using a single CMUT and/or PMUT transducer element, an array of such CMUT and/or PMUT transducers can be employed to operate together to improve the performance. For example, a number of such CMUT and/or PMUT transducers can be placed along arms of a smart eyeglasses with uniform or nonuniform spacing to form a linear transducer array. Certain beamforming techniques can be applied to control the directionality of the radiation pattern so that a sound level at an ear canal entrance can be at a preferred level. An array of CMUT and/or PMUT transducers can also be used to detect the motion gesture for a new user interface. An array of CMUT and/or PMUT transducers can also be used for implementing an imaging technique to detect an ear shape for a personalized sound equalization. This can also provide direction information for the transducer array processing to fine tune the radiation pattern for each wearer of smart eyeglasses.

The CMUT and PMUT transducers presented herein may also employ cartilage or bone conduction pathway. With much higher energy penetration of ultrasound, cartilage and/or bone conduction pathways can be leveraged to directly excite an ear-drum or cochlear. This approach may require: (i) tuning of carrier frequencies for more efficient conduction in human tissue, and (ii) design of impedance matching material interfacing between a transducer and human skin.

Multi-Channel Speech Enhancement using Triple-Path Attentive Recurrent Network

Embodiments of the present disclosure are further directed to a triple-path attentive recurrent network (TPARN) for ad-hoc array processing that can be applied at an audio system (e.g., the audio system 200) for multi-channel speech enhancement. A TPARN's dual-path single-channel network may be extended to a multichannel network by adding a third path along a spatial dimension. The self-attention along the spatial dimension is presented herein for ad-hoc arrays to make the TPARN invariant to a number and order of microphones. The TPARN presented herein may improve speech enhancement by placing additional microphones at new locations, even at locations far from existing microphones. The TPARN presented herein may simultaneously enhance signals from all microphones. Additionally, worse-placed microphones at far locations may exhibit biggest improvement in objective scores by utilizing better-placed microphones at closer locations. The TPARN presented herein can be very effective in highly reverberant and noisy conditions. The TPARN for ad-hoc array processing is extended herein by incorporating two major changes. First, using self-attention across the spatial dimension instead of an attentive recurrent network (ARN), the TPARN is made invariant to the number and the order of microphones. Second, a processing order of underlying TPARN processing blocks (e.g., intra-chunk, inter-chunk, and inter-channel blocks) is rearranged based on empirical observations.

A multichannel noisy signal Y∈R^{P×N}, where P is the number of microphones and N is the number of samples, can be modeled as Y=X+N, where X represents a clean speech and N represents noises including background noise and room reverberation recorded at P microphones. Let Xⁱ denote the signal at the i-th microphone. The goal of multichannel speech enhancement is to obtain a close estimate of the clean signal at a reference microphone r, \hat{X}^{r}, from Y.

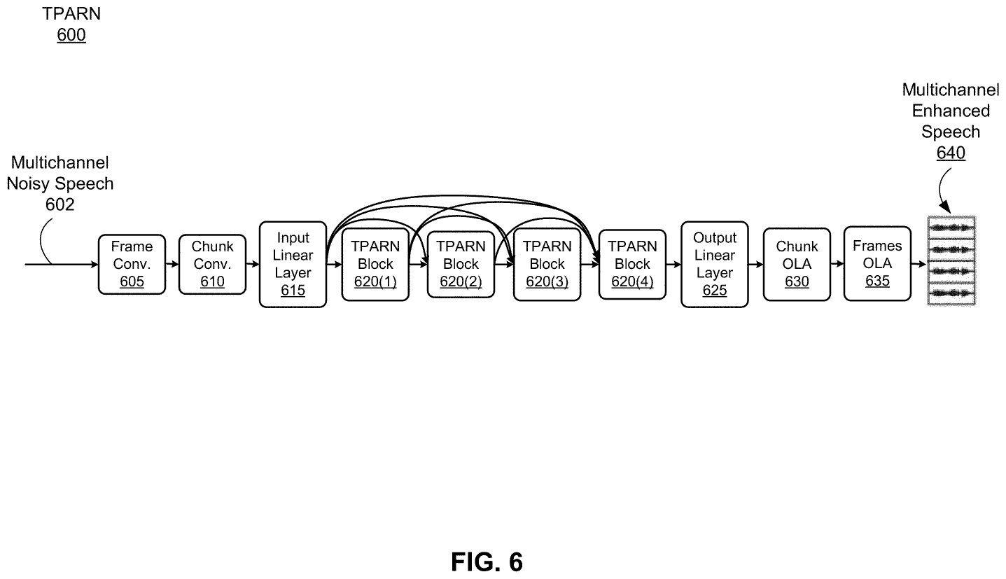

FIG. 6 is a block diagram of a TPARN 600 for an ad-hoc array multichannel speech enhancement, in accordance with one or more embodiments. The TPARN 600 represents a multiple-input multiple-output (MIMO) processing architecture that enhances all input channels simultaneously. The TPARN 600 may include: a frame conversion block 605, a chunk conversion block 610, an input linear layer 615, TPARN blocks 620(1), 620(2), 620(3), 620(4), an output linear layer 625, a chunk overlap-and-add (OLA) block 630, and a frame OLA block 635. There may be more or fewer components of the TPARN 600 than what is shown in FIG. 6. The TPARN 600 may be implemented as part of one or more modules of the audio controller 230.

The frame conversion block 605 may convert an input signal comprising a multichannel noisy speech 602 to frames (e.g., T frames each having a size of L samples and frame shift of K samples). The chunk conversion block 610 may group the frames into chunks (e.g., C chunks each having a size of R samples and chunk shift of S samples). The input linear layer 615 may project the frames grouped into the chunks to a size of D samples. The stack of TPARN blocks 620(1), 620(2), 620(3), 620(4) may process the projected frames output by the input linear layer 615.

An input to a TPARN block 620(1), 620(2), 620(3), 620(4) (which is a concatenation of the output from the encoder and outputs from preceding TPARN blocks), is a tensor of shape P×C×R×k·D, where k denotes an identifier of the TPARN block (i.e., k=1, 2, 3, or 4). For k>1, a linear layer may be used at an input of each TPARN block 620(2), 620(3), 620(4) to project features of size k·D samples to D samples. After that, the projected features may be processed using a stack of inter-channel self-attention block, intra-chunk ARN, and inter-chunk ARN within each TPARN block 620(2), 620(3), 620(4). The inter-channel self-attention block may operate along the channel dimension (i.e., spatial dimension) by rearranging its input to shape R·C×P×D and using a self-attention mechanism that treats the first, second and the third dimensions as batch, sequence, and feature dimensions, respectively. Similarly, the intra-chunk ARN may process all chunks independently by rearranging its input to shape P·C×R× D. The inter-chunk ARN may combine chunks by rearranging its input to shape R·C×P×D.

The output linear layer 625 may project an output of the TPARN block 620(4) to size L samples. The chunk OLA block 630 may combine chunks of samples from the output linear layer 625. The frame OLA block 635 may combine frames from the chunk OLA block 630 to generate an enhanced multichannel waveform comprising a multichannel enhanced speech.

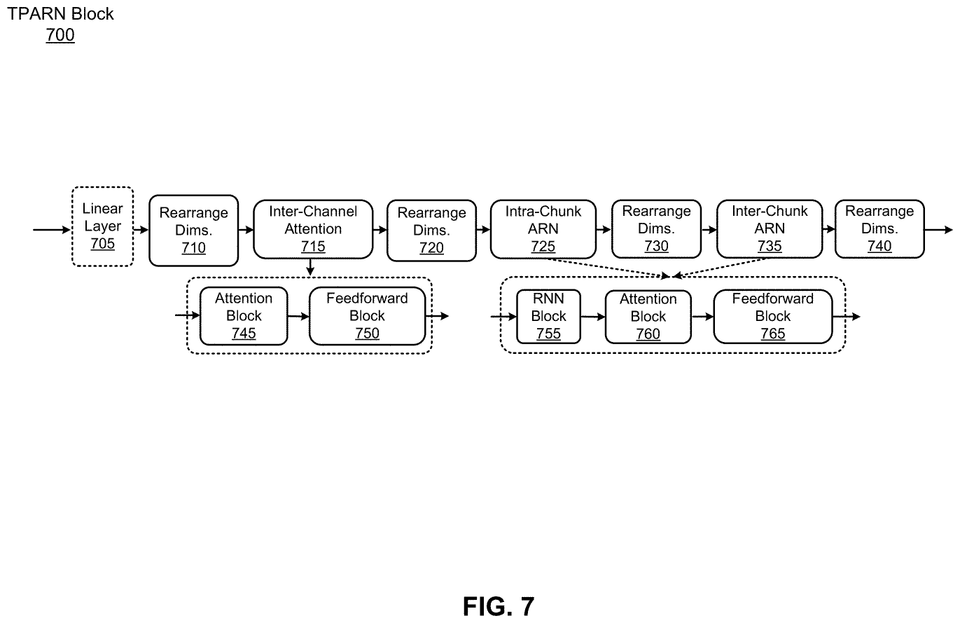

FIG. 7 is a block diagram of a TPARN block 700, in accordance with one or more embodiments. The TPARN block 700 may be an embodiment of any of the TPARN blocks 620(1), 620(2), 620(3), 620(4). The TPARN block 700 may include: a linear layer 705, a rearrange dimensions block 710, an inter-channel attention block 715, a rearrange dimensions block 720, an intra-chunk ARN 725, a rearrange dimensions block 730, an inter-chunk ARN 735, and a rearrange dimensions block 740. There may be more or fewer components of the TPARN block 700 than what is shown in FIG. 7.

The inter-channel attention block 715 may include a stack of an attention block 745 and a feedforward block 750. The inter-channel attention block 715 may operate along the channel dimension (i.e., spatial dimension) by rearranging its input to a defined shape (e.g., R·C×P×D shape) and employ a self-attention mechanism that treats the first, second and the third dimensions as batch, sequence, and feature dimensions, respectively. Each of the intra-chunk ARN 725 and the inter-chunk ARN 735 may include a respective stack of three blocks, a respective recurrent neural network (RNN) block 755, a respective attention block 760, and a respective feedforward block 765. The intra-chunk ARN 725 may process all chunks independently by rearranging its input to a specific shape (e.g., P·C×R×D shape). The inter-chunk ARN 735 may combine chunks by rearranging its input to a specific shape (e.g., R·C×P×D shape).

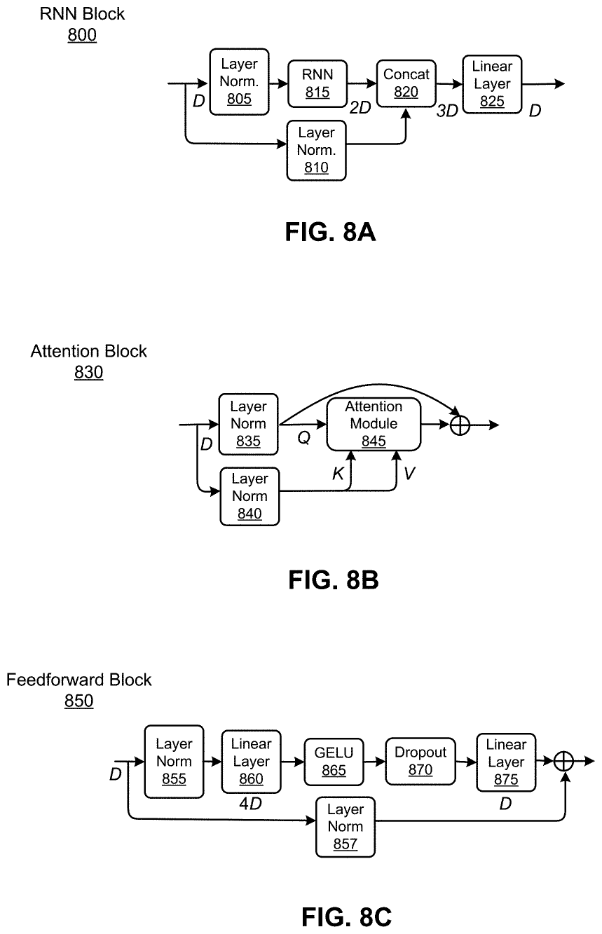

FIG. 8A is a block diagram of a RNN block 800, in accordance with one or more embodiments. The RNN block 800 may be an embodiment of the RNN block 755. The RNN block 800 may include: a layer-normalization layer 805, a layer-normalization layer 810, a RNN 815, a concatenation block 820, and a linear layer 825. There may be more or fewer components of the RNN block 800 than what is shown in FIG. 8A.

The two independent layer-normalization layers 805 and 810 may normalize an input into the RNN block 755 (of hidden size D). A first layer-normalized input generated by the layer-normalization layer 805 may be fed into an RNN 815 of hidden size 2D. The concatenation block 820 may concatenate an output of the RNN 815 with a second layer-normalized input generated by the layer-normalization layer 810 to generate a concatenated output of hidden size 3D. The linear layer 825 may project the concatenated output to an output of the RNN block 800 of size D.

FIG. 8B is a block diagram of an attention block 830, in accordance with one or more embodiments. The attention block 830 may be an embodiment of the attention block 745 or the attention block 760. The attention block 830 may include a layer-normalization layer 835, a layer-normalization layer 840, and an attention module 845. There may be more or fewer components of the attention block 830 than what is shown in FIG. 8B.

An input to the attention block 830 may be layer-normalized using the two independent layer-normalization layers 835, 840. A first layer-normalized input generated by the layer-normalization layer 835 may be used as query, Q. A second layer-normalized input generated by the layer-normalization layer 840 may be used as key K and value V for the attention module 845. The attention module 845 may use a self-attention mechanism to process the query, Q, key, K, and value, V. An output of the attention module 845 may be added to the second layer-normalized input generated by the layer-normalization layer 840 to form a residual connection.

FIG. 8C is a block diagram of a feedforward block 850, in accordance with one or more embodiments. The feedforward block 850 may be an embodiment of the feedforward block 750 or the feedforward block 765. The feedforward block 850 may include: a layer-normalization layer 855, a layer-normalization layer 857, a linear layer 860, a Gaussian error linear unit (GELU) 865, a dropout block 870 and a linear layer 875. There may be more or fewer components of the feedforward block 850 than what is shown in FIG. 8C.

An input to the feedforward block 850 may be layer-normalized independently using the two different layer-normalization layers 855, 857. The linear layer 860 may project a first layer-normalized input generated by the layer-normalization layer 855 to generate a projected input of size 4D. The GELU 865 may apply a nonlinear processing to the projected input to generate a nonlinear output. The dropout block 870 may apply dropout (e.g., with a dropout rate of Dr) to samples of the nonlinear output. The linear layer 875 may project an output of the dropout block 870 back to a projected output of size D samples. The projected output may be added to a second layer-normalized input generated by the layer-normalization layer 857 to generate an output of the feedforward block 850. It should be noted that that dense connections can be used in the RNN block 800, whereas residual connections can be used in the attention block 830 and the feedforward block 850.

Sound Enhancement using Triple-Path Attentive Recurrent Network

Deep neural networks (DNNs) are generally coupled with one or more spatial filters (e.g., MVDR beamformer) for exploiting spatial information. Single-stage end-to-end supervised models can provide substantial sound enhancement. Moreover, utilizing the end-to-end supervised models in a multistage scheme with a beamformer and a DNN-based post-filter may provide additional improvements in sound enhancement. Embodiments of the present disclosure are directed to a two-stage scheme for multichannel speech enhancement that does not require a beamformer. A novel attentive dense convolutional network (ADCN) for multichannel complex spectral mapping (CSM) is presented herein. The ADCN is an encoder-decoder based convolutional neural network (CNN) architecture where layers within the encoder and decoder are augmented with dense blocks and attention blocks for context aggregation. Furthermore, different models are evaluated in a two-stage scheme with and without an MVDR beamformer. Two CSM models are evaluated herein: (i) ADCN and a dense convolutional recurrent network (DCRN), and one waveform mapping (WM) model TPARN. Improvements due to the MVDR beamformer can be observed only when similar approaches to speech enhancement, such as CSM are used in both stages. It can be also noticed that the improvements from the MVDR beamformer diminishes with a stronger model in the first stage. For example, with stronger models (e.g., ADCN and TPARN), consistent or significant improvements from the MVDR beamformer cannot be observed.

A multichannel noisy speech x=[x₁, . . . , xₚ]∈R^{P×N} with N samples and P microphones can be modeled as:

$$\begin{matrix}{x}_{m} ( n ) = {y}_{m} ( n ) + {z}_{m} ( n ) \\ = {h}_{m} ( n ) * s ( n ) + {z}_{m} ( n ) \\ = {g}_{m} ( n ) * s ( n ) + [ ( {h}_{m} - {g}_{m} ) ( n ) * s ( n ) + {z}_{m} ( n ) ] \\ = {d}_{m} ( n ) + {u}_{m} ( n )\end{matrix} \qquad ( 1 )$$

where m=1, 2, . . . , P, n=0, 1, . . . , N−1, s is the source speech, yₘ and zₘ are respectively the reverberated speech and the noise received at the m-th microphone, * denotes convolution operator, hₘ is a room impulse response (RIR) of the source speech, gₘ is a direct-path RIR of the source speech that is ideally a scaled and shifted delta operator to incorporate for the delay and the attenuation in the arrival of the source speech, dₘ is a direct-path source speech, and uₘ is an overall interference including noise and reverberation. Given a reference microphone r, the goal of a multichannel speech enhancement algorithm is to obtain a good estimate of the direct-path source speech at microphone r, \textcircled{d}ᵣ, from the multichannel noisy speech x.

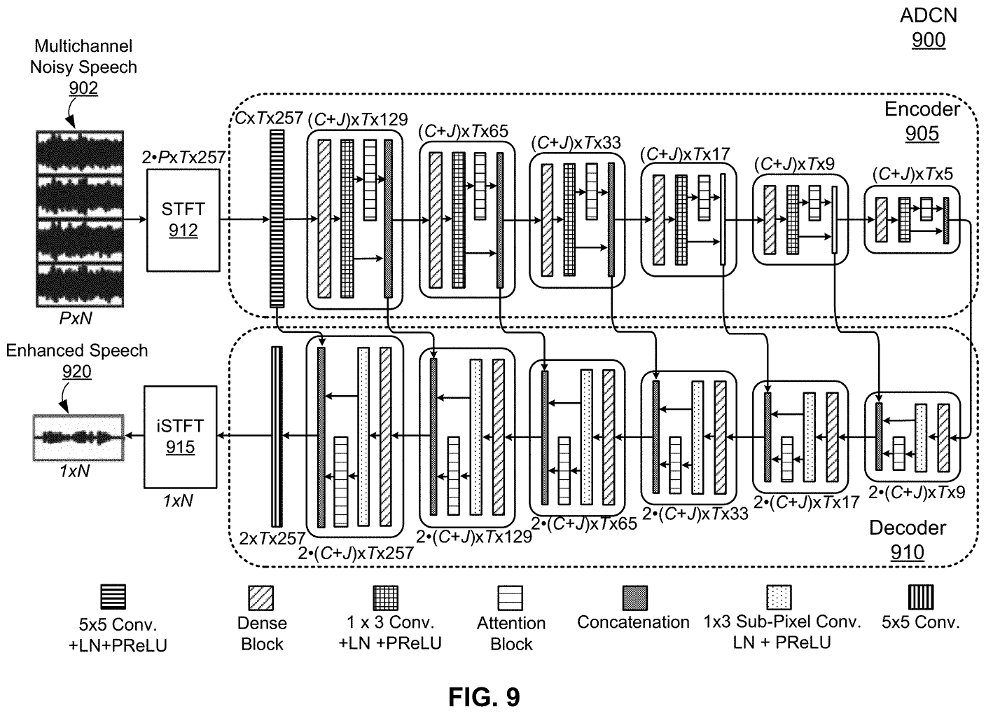

FIG. 9 is a block diagram of an ADCN 900 for multichannel speech enhancement, in accordance with one or more embodiments. The ADCN 900 may perform the CSM based processing to achieve multichannel speech enhancement. The ADCN 900 comprises a CNN architecture with an encoder 905 and a decoder 910. The ADCN 900 further incudes a Short-time Fourier transform (STFT) block 912 coupled to an input of the encoder 905, and an inverse Short-time Fourier transform (iSTFT) block 915 coupled to an output of the decoder 910. There may be more or fewer components of the ADCN 900 than what is shown in FIG. 9. The ADCN 900 may be implemented as part of one or more modules of the audio controller 230.

The STFT block 912 may perform a STFT on time domain input samples of a multichannel noisy speech 902 to generate a processed input in frequency domain for the encoder 905 having a shape of, e.g., 2·P×T×257. A first portion of the encoder (e.g., 5×5 convolutional layer with layer normalization (LN) and parametric rectified linear unit (PReLU)) may transform the processed input into a transformed signal having a shaped of, e.g., C×T×257. Following that, a second portion of the encoder 905 (e.g., last six blocks in the encoder 905 shown in FIG. 9) and a first portion of the decoder 910 (e.g., first six blocks in the decoder 910 in FIG. 9) may process the transformed signal to generate a processed output of, e.g., 2×T×257 shape. The encoder 905 may comprises a stack of a dense block, a 1×3 convolutional block (e.g., using a stride of 2 for down-sampling) with LN and PReLU, and an attention block.

An output of the attention block in the encoder 905 may be concatenated with its input to generate a final output of the encoder 905. Additionally, an output of each block in the decoder 910 may be concatenated to an output of a corresponding symmetric block in the encoder 905. A second portion of the decoder 910 (e.g., 5×5 convolutional layer with two output channels) may generate a final output of the decoder 910 of, e.g., 1×N shape. The iSTFT block 915 may perform an inverse STFT to samples of the final output of the decoder to generate a time domain output waveform comprising an enhanced speech 920. Note that the decoder 910 may have a similar structure as the encoder 905, except that the decoder uses 1×3 sub-pixel convolution for up-sampling instead of strided convolution for down-sampling applied at the encoder 905.

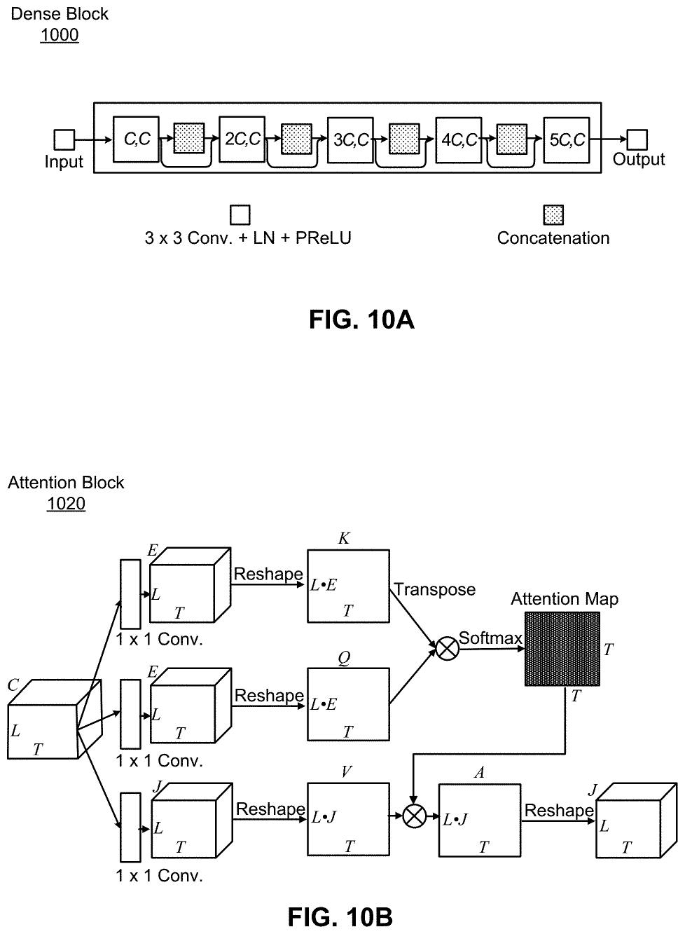

FIG. 10A is a block diagram of a dense block 1000 of the ADCN 900, in accordance with one or more embodiments. The dense block 1000 may comprises a stack of five 3×3 convolutional layer blocks with C output channels, LN and PReLU. There may be more or fewer components of the dense block 1000 than what is shown in FIG. 10. An input to each convolutional layer block in the dense block 1000 may be a concatenation of a respective input to each convolutional layer block and outputs from preceding convolutional layers in the dense block 1000.

FIG. 10B is a block diagram an attention block 1020 of the ADCN 900, in accordance with one or more embodiments. An input of shape C×T×L may be first transformed using three separate 1×1 convolutional layers to obtain a query Q, key K, and value V of shapes E×T×L, E×T×L, and J×T×L, respectively. Then, the query Q, key K, and value V may be reshaped to two-dimensional tensors of shapes E·L×T, E·L×T, and J·L×T, respectively. After that, an output from attention, A, may be computed as A=Softmax(Q×K^{T})×V and having a shaped of J·L×T. Finally, the output A may be reshaped to a three-dimensional tensor of shape J×T×L.

Embodiments of the present disclosure further relate to evaluating DCRN, ADCN and TPARN models using two stages for multichannel speech enhancement.

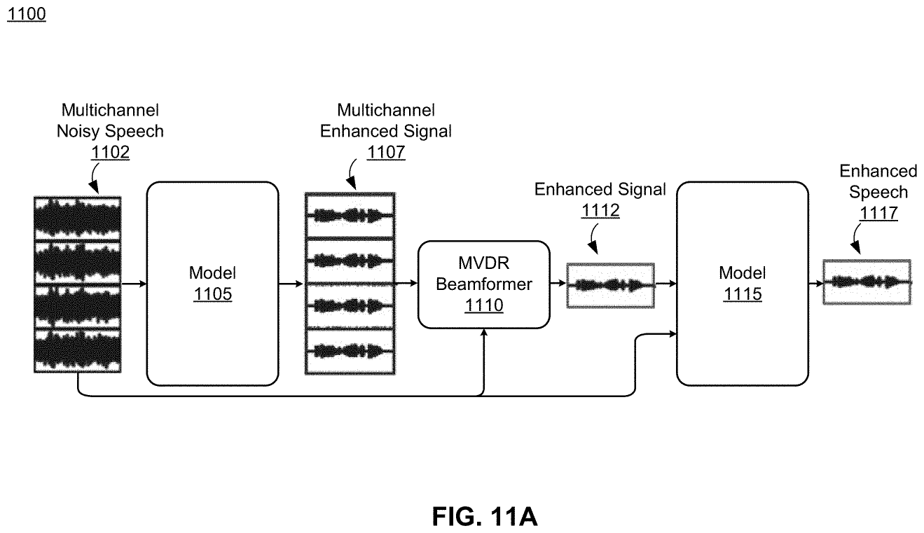

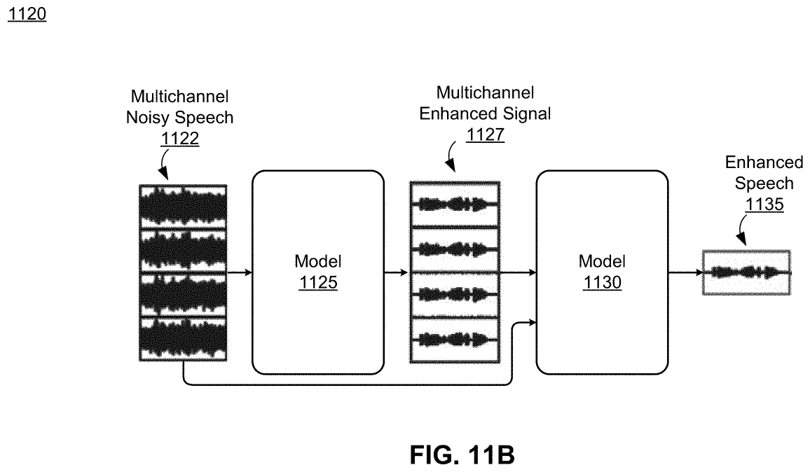

FIG. 11A is a block diagram of a two-stage sound-enhancement architecture 1100 with a MVDR beamformer, in accordance with one or more embodiments. The two-stage sound-enhancement architecture 1100 may include a model 1105, a MVDR beamformer 1110, and a model 1115. There may be more or fewer components of the two-stage sound-enhancement architecture 1100 than what is shown in FIG. 11A. The two-stage sound-enhancement architecture 1100 may be implemented as part of one or more modules of the audio controller 230.

The model 1105 may be first trained to estimate enhanced speech at all channels. The model 1105 may be a TPARN model (i.e., MIMO model) model. The model 1105 may process input samples of a multichannel noise speech 1102 to generate a multichannel enhanced signal 1107. The MVDR beamformer 1110 may estimate beamformer coefficients using the multichannel enhanced signal 1107 at all channels. The MVDR beamformer 1110 may be implemented as a time-invariant MVDR (TI-MVDR) beamformer. A sound source used herein can be considered static within each utterance, and reverberation and background noise are considered to be diffuse. Hence, the MVDR beamformer 1110 implemented as a TI-MVDR is more suitable herein than a time-varying MVDR beamformer. The MVDR beamformer 1110 may use the estimated beamformer coefficients to generate a single channel enhanced signal 1112 from the multichannel enhanced signal 1107.

The model 1115 may be trained to map the multichannel noise speech 1102 and the enhanced signal 1112 from the MVDR beamformer 1110 to an enhanced speech 1117. The model 1115 may include a DCRN and ADCN, i.e., the model 1115 may be a multiple-input and single-output (MISO) model. Hence, the model 1115 may enhance each channel independently by running the enhancement model P times for P channels. An output for the m-th microphone may be computer at the model 1115 by using a circularly shifted input. This is suitable as a symmetric circular microphone array is used.

FIG. 11B is a block diagram of a two-stage sound-enhancement architecture 1120 without a MVDR beamformer, in accordance with one or more embodiments. The two-stage sound-enhancement architecture 1120 may include a model 1125, and a model 1130. There may be more or fewer components of the two-stage sound-enhancement architecture 1120 than what is shown in FIG. 11B. The two-stage sound-enhancement architecture 1120 may be implemented as part of one or more modules of the audio controller 230.

The model 1125 may be first trained to estimate enhanced speech at all channels. The model 1125 may be a TPARN model (i.e., MIMO model) model. The model 1125 may process input samples of a multichannel noise speech 1122 to generate a multichannel enhanced signal 1127. The model 1130 may be trained to map the multichannel noise speech 1122 and the multichannel enhanced signal 1127 to an enhanced speech 1135 at a reference channel. The model 1130 may include a DCRN and ADCN, i.e., the model 1130 may be a MISO model. Hence, the model 1130 may enhance each channel independently by running the enhancement model P times for P channels.

### Low Latency Low Power DSP Control Architecture

An architecture with low latency and low power digital signal processing and control is presented herein. The architecture is based on distributing a computation of digital signal processing algorithms among slow and fast processing paths. A portion of the algorithm dependent on more recent information may be executed on the fast processing path, and another portion of the algorithm dependent on older information may be executed on the slow processing path. Outputs of each processing path may be combined to generate a target algorithm output in a timely manner. The digital signal processing architecture presented herein reduces latency associated with transferring samples out of analog-to-digital converters (ADCs) and into digital-to-analog converters (DACs). It should be noted that the discrete convolution implementing a finite impulse response (FIR) filter discussed below is one example of digital signal processing and should not be limiting. The architecture presented herein may also reduce a number of bits used to represent digitized samples that are being processed at high rates such as in, e.g., active noise cancellation (ANC) applications. Thereby, the presented approach results in various system level benefits due to the achievement of reduced power consumption, reduced memory and reduced latency. The architecture presented herein is also designed to meet system level requirements including low latency, low power consumption and multi-chip implementation.

Some embodiments of the present disclosure relate to a method that divides a set of samples (e.g., from an ADC) into a first set of samples and a second set of samples, wherein the first set of samples are associated with a more recent set of time values than the second set of samples. The first set of samples may be processed using a first digital signal processor (DSP), and the second set of samples may be processed using a second DSP. The second DSP may be slower than the first DSP. Outputs from the first DSP and the second DSP may be then combined to form a combined output. The combined output may be representative of a filtering operation being applied to the set of samples. The combined output may then be provided to, e.g., a DAC. Use of the first DSP and the second DSP can reduce latency associated with transferring samples out of ADCs and into DACs.

An amount of time, TDSP, can be attributed to a common type of filter (e.g., FIR filter) used by DSP applications. Mathematically, the FIR filter can be described by the following difference equation (also known as the discrete convolution):

y[k]=Σᵢ₌₀^{N}bi·x[k−i] (2)

where N is a filter order, x[k] is an input sample at instant k*Ts, y[k] is an output sample at instant k*Ts, and bi is an i-th filter coefficient multiplying [k−i]-th input sample.

As the order N of the filter increases, so does the amount of memory required to store all input samples and filter coefficients, as well as an amount of processor cycles to finish the convolution operation. Therefore, with a separated architecture, satisfying latency constraints can be particularly difficult for high sampling rates. An architecture and method is presented herein to allow DSP and control systems having large number of computations (i.e., high TDSP) and relatively high sample transfer delays Tdly to be executed at small sampling periods while keeping the overall input-output latency below a defined threshold latency.

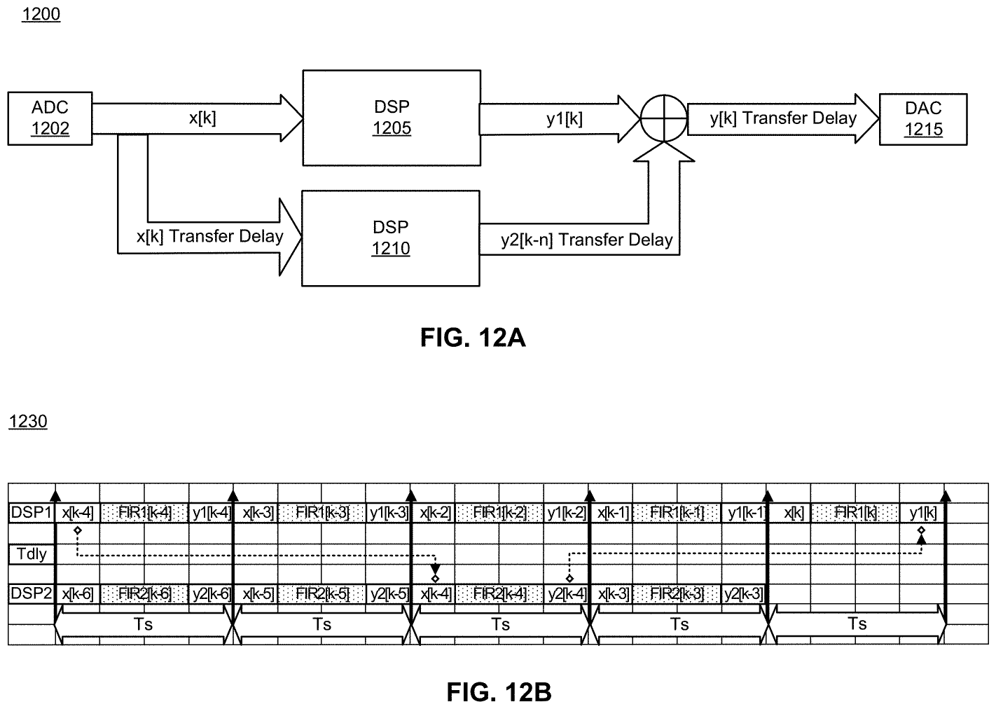

FIG. 12A illustrates an example architecture 1200 for splitting the convolution calculation between two DSPs, in accordance with one or more embodiments. The architecture 1200 may include ADC 1202, DSP 1205, DSP 1210, and DAC 1215. There may be more or fewer components of the architecture 1200 than what is shown in FIG. 12A. The architecture 1200 may be implemented as part of one or more modules of the audio controller 230.

Note that Equation (2) can be re-written as an addition operation between two convolutions defined as:

y[k]=y1[k]+y2[k−n] (3)

y1[k]=Σᵢ₌₀ⁿ⁻¹bi·x[k−i] (4)

y2[k−n]=Σᵢ₌ₙ^{N}bi·x[k−i] (5)

where n−1 is a filter order of FIR filter implemented on a DSP 1205, and N is a total filter order (i.e., filter order of a cumulative FIR filter implemented at the DSP 1205 and the DSP 1210). If the choice of where n splits the FIR filter is properly selected to account for sources of delay T_{dly}, then the architecture 1200 may guarantee that a large convolution is executed in a very short amount of sampling time Ts without being delayed by the amount of time it takes for the samples to move through the large DSP 1210. In this way, the DSP 1205 may be a much smaller and faster processor belonging to a Codec that also includes the ADC 1202 and the DAC 1215.

FIG. 12B illustrates an example timing diagram 1230 for the convolution split, in accordance with one or more embodiments. The convolution split may be at n−4 and transfer delays may be 2*Ts. It can be observed from the timing diagram 1230 that n≥Tdly_total/Ts is chosen so that the result y2[k−n] of convolution performed at the DSP 1210 arrives in time to be added to the result y1[k] of convolution performed at the DSP 1205, thus yielding y[k] that is sent to the DAC 1220. It should be noted that the choice of 2 DSP cores (or co-processors) 1205, 1210 is merely exemplary and by any means should it limit the extension to multiple cores and/or multiple convolutions (i.e., to more than two DSPs and more than two convolutions). It should be noted that by keeping n small, an amount of memory and computation performed by the DSP 1205 is reduced and therefore a design of the DSP 1205 may be more easily optimized for low input-output latency and low sampling time Ts. In some embodiments, n may be increased to allow longer transfer delays of the x samples and y2 samples (e.g., through serial audio interfaces), and thus keep a clock rate from becoming higher than a defined threshold rate.

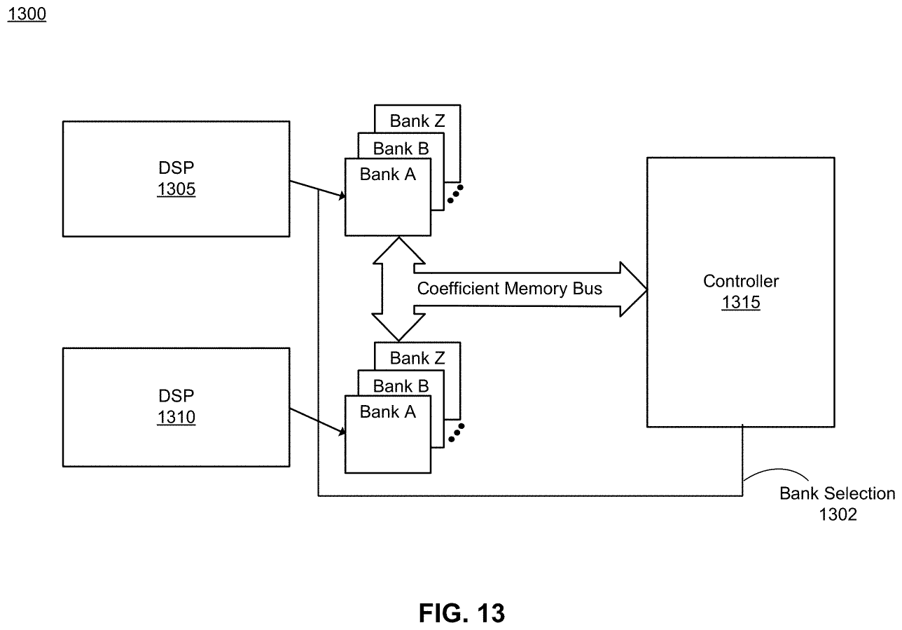

FIG. 13 illustrates an example block diagram 1300 of a coefficient bank switching control, in accordance with one or more embodiments. The filter coefficients may be adapted to modify the FIR filter characteristics, e.g., at an adaptation rate lower than the sampling rate Fs. A method is presented herein to change (adapt) the filter coefficients by writing new filter coefficients to shadow memory banks not actively used by the FIR filter. Upon writing all the filter coefficients, a bank selection command 1302 may be sent out synchronously to both DSPs 1305, 1310 in order to atomically activate the banks containing the filter coefficients. A controller 1315 coupled to the DSPs 1305, 1310 may run a least mean square (LMS) algorithm responsible for generating the modified filter coefficients. The approach presented herein can also be applied to the case where independent DSPs share a common physical memory containing all coefficient banks.

In some embodiments, an additional enhancement to the architecture 1200 is achieved by reducing the number of bits used to represent samples required for the convolution operation. One benefit of the additional enhancement would be lowering an amount of memory for storing the array (or arrays) of samples. Another benefit of the additional enhancement would be reducing the power and silicon resources dedicated to implementing the multiply operations bi*x[k−i] of the convolution, for instance by reducing the multiply operations from 32×32 bits to 32×16, 32×8, 24×8, etc. Finally, it takes less time to transfer input and output samples x[k] and y[k] between the DSPs, lowering latency and/or reducing the requirement for high communication clock frequency. For applications such as headphone ANC, keeping Ts small helps achieving better performance and/or stability margins and therefore prevents oscillations that cause the speaker to “squeal” at times. The use of smaller Ts (or equivalently higher sampling frequency Fs) may cause the ANC algorithm to operate at a sampling rate that is higher than a typical Nyquist rate (e.g., Fn=24 kHz) of a consumer quality audio playback application, therefore creating an opportunity for x[k] samples to be quantized with a lower number of bits while maintaining the quantization noise outside the listening band of interest (e.g., Fn). A few sampling rates considered for running the ANC algorithms are listed in Table I, with the corresponding oversampling rates (OSR) calculated as defined.

TABLE I
Oversampling rates for various
ANC sampling frequencies.

| Fs | OSR = |
|---|---|
| [kHz] | Fs/(2*Fn) |
| 48 | 1 |
| 96 | 2 |
| 192 | 4 |
| 384 | 8 |
| 768 | 16 |

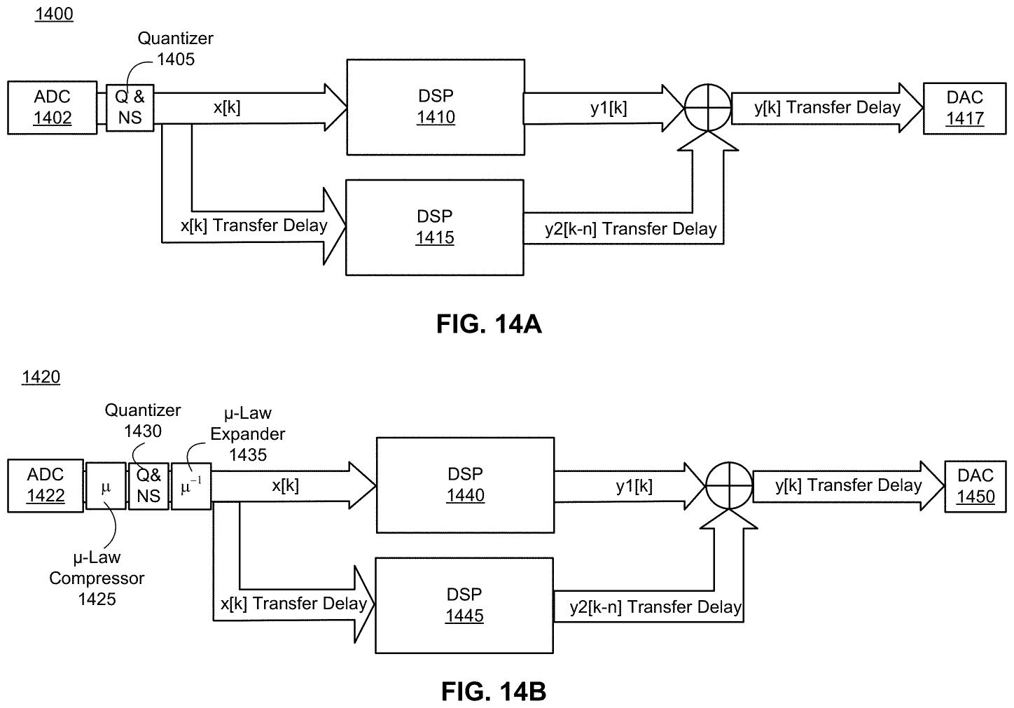

FIG. 14A illustrates an example signal processing architecture 1400 with a quantizer for splitting a convolution calculation between two DSP paths, in accordance with one or more embodiments. The signal processing architecture 1400 may include an ADC 1402, a quantizer 1405, a DSP 1410, a DSP 1415, and a DAC 1417. There may be more or fewer components of the signal processing architecture 1400 than what is shown in FIG. 14A. The signal processing architecture 1400 may be implemented as part of one or more modules of the audio controller 230.

The quantizer 1405 may quantize samples from the ADC 1402, and the quantized samples may be then split to the DSP 1410 and the DSP 1415 for two separate convolutions. Outputs of the DSPs 1410, 1415 may be then combined and fed into the DAC 1417. The quantizer 1405 may facilitate reducing the number of bits of the input samples coming from the ADC 1402.

During the quantization process performed at the quantizer 1405, noise that can be detrimental to a pleasant listening experience may be added to the continuous signal sampled by the ADC 1402. A technique used herein is to move that noise out of the audible band into the higher inaudible range of the frequency spectrum, which can be referred to as “noise shaping.” In general, the higher the oversampling rate the lower the number of bits that the quantization process can utilize while maintaining acceptable levels of noise within the audible range.

One immediate solution to keep the quantization noise from entering the audible range is to increase the sampling rate Fs from, e.g., 192 kHz to 384 kHz or higher. However, such a solution happens at the expense of incurring higher power consumption due to increased computation rate. To maintain the same Fs=192 kHz and low 8 bits, nonlinear quantization using μ-law as shown in FIG. 14B can be used.

FIG. 14B illustrates an example signal processing architecture 1420 with a nonlinear quantization for splitting a convolution calculation between two DSP paths, in accordance with one or more embodiments. The signal processing architecture 1420 may include an ADC 1422, a μ-law compressor 1425, a quantizer 1430, a μ-law expander 1435, a DSP 1440, a DSP 1445, and a DAC 1450. There may be more or fewer components of the signal processing architecture 1420 than what is shown in FIG. 14B. The signal processing architecture 1420 may be implemented as part of one or more modules of the audio controller 230.

The μ-law compressor 1425, the quantizer 1430 and the μ-law expander 1435 may perform the nonlinear quantization. Alternatively or additionally, a spectrum of the quantization noise may be shaped at the-law compressor 1425, the quantizer 1430 and the μ-law expander 1435 such that the quantization noise becomes minimally audible or provide the preferred listening experience in the psychoacoustic sense. For example, with placement of a notch at 13 kHz, there is a small increase of the noise from in the 1 kHz to 10 KHz range but reduction in the 10 kHz to 20 kHz range.

The noise energy moved out of the audible range may appears at higher frequencies, which could negatively impact certain performance characteristics of the system. For example, if the quantized signal is sent to an audio amplifier connected to a loudspeaker load, excessive power dissipation may occur depending on its impedance characteristics. It is common to find loudspeakers (i.e., receivers) having high impedance and therefore low power dissipation due to quantization noise. Such receivers may be of the balanced armature type and typically unable to generate enough sound pressure at low frequencies to meet bass levels normally expected from consumer audio products. On the other hand, loudspeakers of the electrodynamic type typically produce more bass response but dissipate more of the quantization noise power due to their lower impedance characteristic. To prevent quantization noise from leaving the digital domain, a low-pass filter can be cascaded after the noise shaping block.

A method is presented herein for distributing a computation of an algorithm among slow and fast processing paths. A set of signal samples may be divided into a first set of samples and a second set of samples, wherein the first set of samples are associated with a more recent set of time values than the second set of samples. The first set of samples is processed using a first DSP of the headset. The second set of samples is processed using a second DSP of the headset, wherein the second DSP is slower than the first DSP. Outputs from the first DSP and the second DSP are combined to form a combined output for presentation to the user, the combined output representative of a filtering operation being applied to the set of signal samples.

### Process Flow

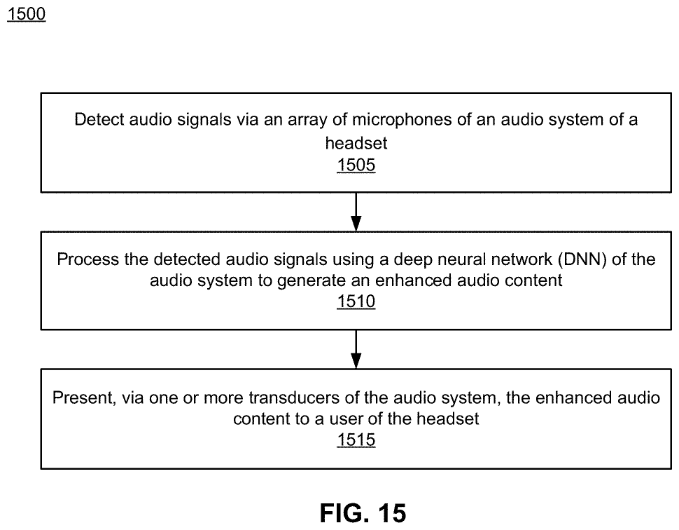

FIG. 15 is a flowchart illustrating a process 1500 for multi-channel speech enhancement at an audio system, in accordance with one or more embodiments, in accordance with one or more embodiments. The process 1500 shown in FIG. 15 may be performed by various components of the audio system (e.g., components shown in FIG. 6, FIG. 7, and FIGS. 8A-8C). The audio system may be the audio system 200. Other entities may perform some or all of the steps in FIG. 15 in other embodiments (e.g., components shown in FIG. 9, FIGS. 10A-10B, and FIGS. 11A-11B). Embodiments may include different and/or additional steps, or perform the steps in different orders.

The audio system detects 1505 audio signals via an array of microphones. The array of microphones may be mounted on a headset that includes the audio system.

The audio system processes 1510 the detected audio signals using a DNN to generate enhanced audio content. The DNN may be trained using sounds detected by a subset of the microphones in the array. The subset of microphones may be mounted at random locations of the headset, and a number of the microphones in the subset may be randomly selected. In some embodiments, the audio system performs time-domain multichannel enhancement of the detected audio signals using a TPARN model of the DNN. A single-channel dual-path model may be extended to a multichannel model in the TPARN model by including a path along a spatial dimension for multichannel processing of the detected audio signals. In some other embodiments, the audio system processes the detected audio signals using an ADCN model of the DNN to generate a plurality of intermediate audio signals, and the audio system processes the intermediate audio signals using a TPARN model of the DNN coupled to the ADCN model to generate the enhanced audio content.

The audio system presents 1515 (e.g., via one or more transducers) the enhanced audio content to a user of the headset. In some embodiments, the one or more transducers are configured to output, in accordance with audio instructions, one or more ultrasonic pressure waves simulating a virtual audio source near an ear of the user. The one or more transducers may comprise an array of micromachined ultrasound transducers. The array of micromachined ultrasound transducers may comprises at least one of: one or more CMUTs, and one or more PMUTs. Alternatively, the one or more transducers may comprise a phased array of ultrasonic speakers.

### System Environment

FIG. 16 is a system 1600 that includes a headset 1605, in accordance with one or more embodiments. In some embodiments, the headset 1605 may be the headset 100 of FIG. 1A or the headset 105 of FIG. 1B. The system 1600 may operate in an artificial reality environment (e.g., a virtual reality environment, an augmented reality environment, a mixed reality environment, or some combination thereof). The system 1600 shown by FIG. 16 includes the headset 1605, an input/output (I/O) interface 1610 that is coupled to a console 1615, the network 1620, and the mapping server 1625. While FIG. 16 shows an example system 1600 including one headset 1605 and one I/O interface 1610, in other embodiments any number of these components may be included in the system 1600. For example, there may be multiple headsets each having an associated I/O interface 1610, with each headset and I/O interface 1610 communicating with the console 1615. In alternative configurations, different and/or additional components may be included in the system 1600. Additionally, functionality described in conjunction with one or more of the components shown in FIG. 16 may be distributed among the components in a different manner than described in conjunction with FIG. 16 in some embodiments. For example, some or all of the functionality of the console 1615 may be provided by the headset 1605.

The headset 1605 includes a display assembly 1630, an optics block 1635, one or more position sensors 1640, a DCA 1645, and an audio system 1650. Some embodiments of headset 1605 have different components than those described in conjunction with FIG. 16. Additionally, the functionality provided by various components described in conjunction with FIG. 16 may be differently distributed among the components of the headset 1605 in other embodiments, or be captured in separate assemblies remote from the headset 1605.

The display assembly 1630 displays content to the user in accordance with data received from the console 1615. The display assembly 1630 displays the content using one or more display elements (e.g., the display elements 120). A display element may be, e.g., an electronic display. In various embodiments, the display assembly 1630 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 1635.

The optics block 1635 may magnify image light received from the electronic display, corrects optical errors associated with the image light, and presents the corrected image light to one or both eye boxes of the headset 1605. In various embodiments, the optics block 1635 includes one or more optical elements. Example optical elements included in the optics block 1635 include: an aperture, a Fresnel lens, a convex lens, a concave lens, a filter, a reflecting surface, or any other suitable optical element that affects image light. Moreover, the optics block 1635 may include combinations of different optical elements. In some embodiments, one or more of the optical elements in the optics block 1635 may have one or more coatings, such as partially reflective or anti-reflective coatings.

Magnification and focusing of the image light by the optics block 1635 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 1635 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 1635 corrects the distortion when it receives image light from the electronic display generated based on the content.

The position sensor 1640 is an electronic device that generates data indicating a position of the headset 1605. The position sensor 1640 generates one or more measurement signals in response to motion of the headset 1605. The position sensor 190 is an embodiment of the position sensor 1640. Examples of a position sensor 1640 include: one or more IMUs, one or more accelerometers, one or more gyroscopes, one or more magnetometers, another suitable type of sensor that detects motion, or some combination thereof. The position sensor 1640 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 1605 from the sampled data. For example, the IMU integrates the measurement signals received from the accelerometers over time to estimate a velocity vector and integrates the velocity vector over time to determine an estimated position of a reference point on the headset 1605. The reference point is a point that may be used to describe the position of the headset 1605. While the reference point may generally be defined as a point in space, however, in practice the reference point is defined as a point within the headset 1605.

The DCA 1645 generates depth information for a portion of the local area. The DCA includes one or more imaging devices and a DCA controller. The DCA 1645 may also include an illuminator. Operation and structure of the DCA 1645 is described above with regard to FIG. 1A.

The audio system 1650 provides audio content to a user of the headset 1605. The audio system 1650 is substantially the same as the audio system 200 described above. The audio system 1650 may comprise one or acoustic sensors, one or more transducers, and an audio controller. The audio system 1650 may provide spatialized audio content to the user. In some embodiments, the audio system 1650 may request acoustic parameters from the mapping server 1625 over the network 1620. The acoustic parameters describe one or more acoustic properties (e.g., room impulse response, a reverberation time, a reverberation level, etc.) of the local area. The audio system 1650 may provide information describing at least a portion of the local area from e.g., the DCA 1645 and/or location information for the headset 1605 from the position sensor 1640. The audio system 1650 may generate one or more sound filters using one or more of the acoustic parameters received from the mapping server 1625, and use the sound filters to provide audio content to the user.

Transducers of the audio system 1650 may be implemented as described above in detail in relation to FIGS. 3A through 5E. Components of the audio system 1650 may enhance sound signals as described above in detail in relation to FIGS. 6 through 11B. Alternatively or additionally, components of the audio system 1650 may perform digital signal processing of audio signals as described above in detail in relation to FIGS. 12A through 14B.

The I/O interface 1610 is a device that allows a user to send action requests and receive responses from the console 1615. An action request is a request to perform a particular action. For example, an action request may be an instruction to start or end capture of image or video data, or an instruction to perform a particular action within an application. The I/O interface 1610 may include one or more input devices. Example input devices include: a keyboard, a mouse, a game controller, or any other suitable device for receiving action requests and communicating the action requests to the console 1615. An action request received by the I/O interface 1610 is communicated to the console 1615, which performs an action corresponding to the action request. In some embodiments, the I/O interface 1610 includes an IMU that captures calibration data indicating an estimated position of the I/O interface 1610 relative to an initial position of the I/O interface 1610. In some embodiments, the I/O interface 1610 may provide haptic feedback to the user in accordance with instructions received from the console 1615. For example, haptic feedback is provided when an action request is received, or the console 1615 communicates instructions to the I/O interface 1610 causing the I/O interface 1610 to generate haptic feedback when the console 1615 performs an action.

The console 1615 provides content to the headset 1605 for processing in accordance with information received from one or more of: the DCA 1645, the headset 1605, and the I/O interface 1610. In the example shown in FIG. 16, the console 1615 includes an application store 1655, a tracking module 1660, and an engine 1665. Some embodiments of the console 1615 have different modules or components than those described in conjunction with FIG. 16. Similarly, the functions further described below may be distributed among components of the console 1615 in a different manner than described in conjunction with FIG. 16. In some embodiments, the functionality discussed herein with respect to the console 1615 may be implemented in the headset 1605, or a remote system.

The application store 1655 stores one or more applications for execution by the console 1615. An application is a group of instructions, that when executed by a processor, generates content for presentation to the user. Content generated by an application may be in response to inputs received from the user via movement of the headset 1605 or the I/O interface 1610. Examples of applications include: gaming applications, conferencing applications, video playback applications, or other suitable applications.

The tracking module 1660 tracks movements of the headset 1605 or of the I/O interface 1610 using information from the DCA 1645, the one or more position sensors 1640, or some combination thereof. For example, the tracking module 1660 determines a position of a reference point of the headset 1605 in a mapping of a local area based on information from the headset 1605. The tracking module 1660 may also determine positions of an object or virtual object. Additionally, in some embodiments, the tracking module 1660 may use portions of data indicating a position of the headset 1605 from the position sensor 1640 as well as representations of the local area from the DCA 1645 to predict a future location of the headset 1605. The tracking module 1660 provides the estimated or predicted future position of the headset 1605 or the I/O interface 1610 to the engine 1665.

The engine 1665 executes applications and receives position information, acceleration information, velocity information, predicted future positions, or some combination thereof, of the headset 1605 from the tracking module 1660. Based on the received information, the engine 1665 determines content to provide to the headset 1605 for presentation to the user. For example, if the received information indicates that the user has looked to the left, the engine 1665 generates content for the headset 1605 that mirrors the user's movement in a virtual local area or in a local area augmenting the local area with additional content. Additionally, the engine 1665 performs an action within an application executing on the console 1615 in response to an action request received from the I/O interface 1610 and provides feedback to the user that the action was performed. The provided feedback may be visual or audible feedback via the headset 1605 or haptic feedback via the I/O interface 1610.

The network 1620 couples the headset 1605 and/or the console 1615 to the mapping server 1625. The network 1620 may include any combination of local area and/or wide area networks using both wireless and/or wired communication systems. For example, the network 1620 may include the Internet, as well as mobile telephone networks. In one embodiment, the network 1620 uses standard communications technologies and/or protocols. Hence, the network 1620 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 1620 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 1620 can be represented using technologies and/or formats including image data in binary form (e.g., Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 1625 may include a database that stores a virtual model describing a plurality of spaces, wherein one location in the virtual model corresponds to a current configuration of a local area of the headset 1605. The mapping server 1625 receives, from the headset 1605 via the network 1620, information describing at least a portion of the local area and/or location information for the local area. The user may adjust privacy settings to allow or prevent the headset 1605 from transmitting information to the mapping server 1625. The mapping server 1625 determines, based on the received information and/or location information, a location in the virtual model that is associated with the local area of the headset 1605. The mapping server 1625 determines (e.g., retrieves) one or more acoustic parameters associated with the local area, based in part on the determined location in the virtual model and any acoustic parameters associated with the determined location. The mapping server 1625 may transmit the location of the local area and any values of acoustic parameters associated with the local area to the headset 1605.

One or more components of system 1600 may contain a privacy module that stores one or more privacy settings for user data elements. The user data elements describe the user or the headset 1605. For example, the user data elements may describe a physical characteristic of the user, an action performed by the user, a location of the user of the headset 1605, a location of the headset 1605, HRTFs for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 1600 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. An audio system, comprising:
one or more transducers coupled to a headset, the one or more transducers configured to output, in accordance with audio instructions, one or more ultrasonic pressure waves simulating a virtual audio source near an ear of a user of the headset; and
a controller coupled to the one or more transducers, the controller configured to generate the audio instructions such that the one or more ultrasonic pressure waves form at least a portion of audio content for presentation to the user.

2. The audio system of claim 1, wherein the one or more transducers comprise an array of micromachined ultrasound transducers.

3. The audio system of claim 2, wherein the array of micromachined ultrasound transducers comprises at least one of: one or more capacitive micromachined ultrasound transducers (CMUTs), and one or more piezoelectric micromachined ultrasound transducers (PMUTs).

4. The audio system of claim 1, wherein the one or more transducers comprise a phased array of ultrasonic speakers.

5. The audio system of claim 1, wherein the audio system further comprises one or more waveguides coupled to the one or more transducers, the one or more waveguides configured to guide the one or more ultrasonic pressure waves to an entrance of an ear canal of the ear.

6. The audio system of claim 1, wherein the ultrasonic pressure waves comprise a haptic feedback for the user.

7. The audio system of claim 1, wherein at least the portion of the audio content presented to the user is experienced by the user as being whispered into the ear.

8. An audio system of a headset, the audio system comprising:
an array of microphones configured to detect audio signals in a local area;
a deep neural network (DNN) coupled to the array of microphones, the DNN configured to process the detected audio signals to generate enhanced audio content; and
one or more transducers coupled to the DNN, the one or more transducers configured to present the enhanced audio content to a user of the headset.

9. The audio system of claim 8, wherein the DNN comprises a triple-path attentive recurrent network (TPARN) model.

10. The audio system of claim 9, wherein the TPARN model is configured for time-domain multichannel enhancement of the detected audio signals.

11. The audio system of claim 9, wherein the TPARN model is configured by including a path along a spatial dimension to extend a single-channel dual-path model into a multichannel model for multichannel processing of the detected audio signals.

12. The audio system of claim 8, wherein the DNN is trained using sounds detected by a subset of the microphones in the array, the subset of microphones mounted at random locations of the headset.

13. The audio system of claim 12, wherein a number of the microphones in the subset is randomly selected.

14. The audio system of claim 8, wherein the DNN comprises:
an attentive dense convolutional network (ADCN) model configured to process the detected audio signals to generate a plurality of intermediate audio signals; and
a triple-path attentive recurrent network (TPARN) model coupled to the ADCN model, the TPARN model configured to process the intermediate audio signals to generate the enhanced audio content.

15. A method performed by an audio system of a headset, the method comprising:
detecting audio signals via an array of microphones of the audio system;
processing the detected audio signals using a deep neural network (DNN) of the audio system to generate enhanced audio content; and
presenting, via one or more transducers of the audio system, the enhanced audio content to a user of the headset.

16. The method of claim 15, further comprising:
performing time-domain multichannel enhancement of the detected audio signals using a triple-path attentive recurrent network (TPARN) model of the DNN.

17. The method of claim 16, further comprising:
extending a single-channel dual-path model to a multichannel model in the TPARN model by including a path along a spatial dimension for multichannel processing of the detected audio signals.

18. The method of claim 15, further comprising:
training the DNN using sounds detected by a subset of the microphones in the array, the subset of microphones mounted at random locations of the headset, and a number of the microphones in the subset is randomly selected.

19. The method of claim 15, further comprising:
processing the detected audio signals using an attentive dense convolutional network (ADCN) model of the DNN to generate a plurality of intermediate audio signals; and
processing the intermediate audio signals using a triple-path attentive recurrent network (TPARN) model of the DNN coupled to the ADCN model to generate the enhanced audio content.

20. The method of claim 15, further comprising:
dividing a set of signal samples into a first set of samples and a second set of samples, wherein the first set of samples are associated with a more recent set of time values than the second set of samples;
processing the first set of samples using a first digital signal processor (DSP) of the headset;
processing the second set of samples using a second DSP of the headset, wherein the second DSP is slower than the first DSP; and
combining outputs from the first DSP and the second DSP to form a combined output for presentation to the user, the combined output representative of a filtering operation being applied to the set of signal samples.
